(19) United States
(12) Patent Application Publication
(10) Pub. No.: US 2024/0421314 A1
(43) Pub. Date: Dec. 19, 2024

(54) BINDER COMPOSITION AND SLURRY COMPOSITION FOR LITHIUM-ION ELECTRICAL STORAGE DEVICES

(71) Applicant: PPG Industries Ohio, Inc., Cleveland, OH (US)

(72) Inventors: Zilu Li, Gibsonia, PA (US); Yurun Yang, Shanghai (CN); Na Zhang, San Jose, CA (US)

(73) Assignee: PPG Industries Ohio, Inc., Cleveland, OH (US)

(21) Appl. No.: 18/695,432

(22) PCT Filed: Sep. 30, 2022
(86) PCT No.: PCT/US2022/077312

§ 371 Date: Mar. 26, 2024

Related U.S. Application Data
(60) Provisional application No. 63/250,339, filed on Sep. 30, 2021.

(51) Int. Cl. H01M 4/62; H01M 4/02; H01M 4/1391; H01M 4/525

(52) U.S. Cl. CPC H01M 4/623; H01M 4/1391; H01M 4/525; H01M 4/624; H01M 2004/028

(57) ABSTRACT

The present invention provides a binder composition comprising (a) at least one fluoropolymer comprising the residue of vinylidene fluoride; and (b) a solvent system comprising (i) a trialkyl phosphate; and (ii) a co-solvent comprising a lactone and/or a molecule comprising a sulfoxide and/or sulfone functional group; wherein the trialkyl phosphate and the co-solvent together comprise at least 50% by weight of the solvent system, based on the total weight of the solvent system. Also disclosed are slurry compositions, electrodes, and electrical storage devices.

### FIELD OF THE INVENTION

The invention relates to binder composition and slurry compositions that could be used in manufacturing films and electrodes for use in electrical storage devices, such as batteries.

### BACKGROUND OF THE INVENTION

There is a trend in the electronics industry to produce smaller devices, powered by smaller and lighter electrical storage devices, such as batteries. Electrical storage devices with a negative electrode, such as those including carbonaceous materials as an electrochemically active material, and a positive electrode, such as those including lithium metal oxides as an electrochemically active material, can provide relatively high power and low weight. Fluoropolymers such as polyvinylidene fluoride (PVDF), because of their excellent electrochemical resistance, have been found to be useful binders for forming electrodes to be used in electrical storage devices. Typically, the PVDF fluoropolymer is dissolved in an organic solvent and the electrode material is combined with the solution to form a slurry that is applied to a metal foil or mesh to form the electrode. The role of the organic solvent is to dissolve the fluoropolymer in order to provide good adhesion between the electrode material particles and the metal foil or mesh upon evaporation of the organic solvent. Currently, the organic solvent of choice is N-methyl-2-pyrrolidone (NMP). PVDF binders dissolved in NMP provide superior adhesion and an interconnectivity of all the active ingredients in the electrode composition. The bound ingredients are able to tolerate large volume expansion and contraction during charge and discharge cycles without losing interconnectivity within the electrodes. Interconnectivity of the active ingredients in an electrode is extremely important in battery performance, especially during charging and discharging cycles, as electrons must move through the electrode, and lithium-ion mobility requires interconnectivity within the electrode between particles. Unfortunately, NMP is a toxic material and presents health and environmental issues.

Alternative technologies to NMP have been developed. However, for the alternative technologies to be useful they must be compatible with current manufacturing practices and provide desired properties of the intermediate and final products. Some common criteria include a viscosity of the slurry appropriate to facilitate good application properties, sufficient interconnectivity within the electrode, sufficient adhesion to the underlying substrate, and sufficient durability of the binder for the resulting electrode coating to the electrolyte in the battery.

### SUMMARY OF THE INVENTION

The present invention provides a binder composition comprising (a) at least one fluoropolymer comprising the residue of vinylidene fluoride; and (b) a solvent system comprising (i) a trialkyl phosphate; and (ii) a co-solvent comprising a lactone and/or a molecule comprising a sulfoxide and/or sulfone functional group; wherein the trialkyl phosphate and the co-solvent together comprise at least 50% by weight of the solvent system, based on the total weight of the solvent system.

The present invention also provides a slurry composition comprising a binder composition comprising (a) at least one fluoropolymer comprising the residue of vinylidene fluoride; and (b) a solvent system comprising: (i) a trialkyl phosphate; and (ii) a co-solvent comprising a lactone and/or a molecule comprising a sulfoxide and/or sulfone functional group; wherein the trialkyl phosphate and the co-solvent together comprise at least 50% by weight of the solvent system, based on the total weight of the solvent system; and an electrochemically active material and/or an electrically conductive agent.

The present invention further provides an electrode comprising (A) an electrical current collector; and (B) a film on the electrical current collector, wherein the film comprises (1) a binder composition comprising (a) at least one fluoropolymer comprising the residue of vinylidene fluoride; and optionally (b) residual solvent comprising a solvent system comprising: (i) a trialkyl phosphate; and (ii) a co-solvent comprising a lactone and/or a molecule comprising a sulfoxide and/or sulfone functional group; wherein the trialkyl phosphate and the co-solvent together comprise at least 50% by weight of the solvent system, based on the total weight of the solvent system; and (2) an electrochemically active material.

The present invention also provides an electrical storage device comprising (a) an electrode comprising (A) an electrical current collector; and (B) a film on the electrical current collector, wherein the film comprises (1) a binder composition comprising at least one fluoropolymer comprising the residue of vinylidene fluoride; and optionally residual solvent comprising a solvent system comprising: (i) a trialkyl phosphate; and (ii) a co-solvent comprising a lactone and/or a molecule comprising a sulfoxide and/or sulfone functional group; wherein the trialkyl phosphate and the co-solvent together comprise at least 50% by weight of the solvent system, based on the total weight of the solvent system; and (2) an electrochemically active material; (b) a counter electrode; and (c) an electrolyte.

### DETAILED DESCRIPTION

The present invention is directed to a binder composition comprising (a) at least one fluoropolymer comprising the residue of vinylidene fluoride; and (b) a solvent system comprising (i) a trialkyl phosphate; and (ii) a co-solvent comprising a lactone and/or a molecule comprising a sulfoxide and/or sulfone functional group.

The binder composition may be used in a slurry composition, and the present invention is also directed to a slurry composition comprising a binder composition comprising (a) at least one fluoropolymer comprising the residue of vinylidene fluoride; and (b) a solvent system comprising (i) a trialkyl phosphate; and (ii) a co-solvent comprising a lactone and/or a molecule comprising a sulfoxide and/or sulfone functional group; and an electrochemically active material and/or an electrically conductive agent.

According to the present invention, the binder composition and/or slurry composition comprises a fluoropolymer comprising the residue of vinylidene fluoride. The fluoropolymer is part of the binder of the slurry composition. The fluoropolymer may comprise a (co)polymer comprising the residue of vinylidene fluoride. A non-limiting example of a (co)polymer comprising the residue of vinylidene fluoride is a polyvinylidene fluoride polymer (PVDF). As used herein, the “polyvinylidene fluoride polymer” includes homopolymers, copolymers, such as binary copolymers, and terpolymers, including high molecular weight homopolymers, copolymers, and terpolymers. Such (co)polymers include those containing at least 50 mole percent, such as at least 75 mole %, and at least 80 mole %, and at least 85 mole % of the residue of vinylidene fluoride (also known as vinylidene difluoride), based on the total moles of monomers that comprise the (co)polymer. Such (co)polymers include those containing at least 50% by weight, such as at least 75% by weight, and at least 80% by weight, and at least 85% by weight of the residue of vinylidene fluoride (also known as vinylidene difluoride), based on the total weight of the (co)polymer. The vinylidene fluoride monomer may be copolymerized with at least one comonomer comprising, consisting essentially of, or consisting of vinyl halide monomers (such as trifluoroethylene, chlorotrifluoroethylene, hexafluoropropene, vinyl chloride, vinyl fluoride, pentafluoropropene, tetrafluoropropene, and the like), vinyl fluoro ethers having the formula F₂C═CF(OR^{F}) where R^{F} is a fluorinated alkyl chain (such as perfluoromethyl vinyl ether, perfluoropropyl vinyl ether, and the like), (meth)acrylic-based monomers (including any of those described herein), and any other monomer that would readily copolymerize with vinylidene fluoride in order to produce the fluoropolymer of the present invention. The fluoropolymer may also comprise a PVDF homopolymer.

The polyvinylidene fluoride may comprise a polyvinylidene fluoride copolymer comprising constitutional units comprising the residue of vinylidene fluoride and at least one of (i) a (meth)acrylic acid; and/or (ii) a hydroxyalkyl (meth)acrylate. The (meth)acrylic acid may comprise acrylic acid, methacrylic acid, or combinations thereof. The hydroxyalkyl (meth)acrylate may comprise a C₁ to C₅ hydroxyalkyl (meth)acrylate, such as, for example, hydroxyethyl (meth)acrylate, 2-hydroxypropyl (meth)acrylate, 2-hydroxybutyl (meth)acrylate, or combinations thereof. A commercially available example of such a polyvinylidene fluoride copolymer includes SOLEF 5130, available from Solvay.

The fluoropolymer may comprise a high molecular weight PVDF having a weight average molecular weight of at least 50,000 g/mol, such as at least 100,000 g/mol, such as at least 250,000 g/mol, such as at least 300,000 g/mol, such as at least 400,000 g/mol, such as at least 600,000 g/mol, such as at least 750,000 g/mol, such as at least 900,000 g/mol, such as at least 1,000,000 g/mol, such as at least 2,000,000 g/mol, such as at least 4,000,000 g/mol, such as at least 5,000,000 g/mol. The fluoropolymer may comprise a high molecular weight PVDF having a weight average molecular weight of no more than 8,000,000 g/mol, such as no more than 6,500,000 g/mol, such as no more than 5,000,000 g/mol, such as no more than 3,000,000 g/mol, such as no more than 1,500,000 g/mol, such as no more than 1,200,000 g/mol, such as no more than 750,000 g/mol. The fluoropolymer may comprise a high molecular weight PVDF having a weight average molecular weight of 50,000 to 8,000,000 g/mol, such as 50,000 to 6,500,000 g/mol, such as 50,000 to 5,000,000 g/mol, such as 50,000 to 3,000,000 g/mol, such as 50,000 to 1,500,000 g/mol, such as 50,000 to 1,000,000 g/mol, such as 50,000 to 750,000 g/mol, such as 100,000 to 8,000,000 g/mol, such as 100,000 to 6,500,000 g/mol, such as 100,000 to 5,000,000 g/mol, such as 100,000 to 3,000,000 g/mol, such as 100,000 to 1,500,000 g/mol, such as 100,000 to 1,200,000 g/mol, such as 100,000 to 750,000 g/mol, such as 250,000 to 8,000,000 g/mol, such as 250,000 to 6,500,000 g/mol, such as 250,000 to 5,000,000 g/mol, such as 250,000 to 3,000,000 g/mol, such as 250,000 to 1,500,000 g/mol, such as 250,000 to 1,200,000 g/mol, such as 250,000 to 750,000 g/mol, such as 300,000 to 8,000,000 g/mol, such as 300,000 to 6,500,000 g/mol, such as 300,000 to 5,000,000 g/mol, such as 300,000 to 3,000,000 g/mol, such as 300,000 to 1,500,000 g/mol, such as 300,000 to 1,200,000 g/mol, such as 300,000 to 750,000 g/mol, such as 400,000 to 8,000,000 g/mol, such as 400,000 to 6,500,000 g/mol, such as 400,000 to 5,000,000 g/mol, such as 400,000 to 3,000,000 g/mol, such as 400,000 to 1,500,000 g/mol, such as 400,000 to 1,200,000 g/mol, such as 400,000 to 750,000 g/mol, such as 600,000 to 8,000,000 g/mol, such as 600,000 to 6,500,000 g/mol, such as 600,000 to 5,000,000 g/mol, such as 600,000 to 3,000,000 g/mol, such as 600,000 to 1,500,000 g/mol, such as 600,000 to 1,200,000 g/mol, such as 600,000 to 750,000 g/mol, such as 750,000 to 8,000,000 g/mol, such as 750,000 to 6,500,000 g/mol, such as 750,000 to 5,000,000 g/mol, such as 750,000 to 3,000,000 g/mol, such as 750,000 to 1,500,000 g/mol, such as 750,000 to 1,200,000 g/mol, such as 900,000 to 8,000,000 g/mol, such as 900,000 to 6,500,000 g/mol, such as 900,000 to 5,000,000 g/mol, such as 900,000 to 3,000,000 g/mol, such as 900,000 to 1,500,000 g/mol, such as 900,000 to 1,200,000 g/mol. PVDF is commercially available, e.g., from Arkema under the trademark KYNAR, from Solvay under the trademark HYLAR, and from Inner Mongolia 3F Wanhao Fluorochemical Co., Ltd.

The fluoropolymer used in preparing the binder may comprise a nanoparticle. As used herein, the term “nanoparticle” refers to particles having a particle size of less than 1,000 nm. The fluoropolymer may have a particle size of at least 50 nm, such as at least 100 nm, such as at least 250 nm, such as at least 300 nm, and may be no more than 900 nm, such as no more than 600 nm, such as no more than 450 nm, such as no more than 400 nm, such as no more than 300 nm, such as no more than 200 nm. The fluoropolymer nanoparticles may have a particle size of 50 nm to 900 nm, such as 100 nm to 600 nm, such as 250 nm to 450 nm, such as 300 nm to 400 nm, such as 100 nm to 400 nm, such as 100 nm to 300 nm, such as 100 nm to 200 nm. As used herein, the term “particle size” refers to average diameter of the fluoropolymer particles. The particle size referred to in the present disclosure was determined by the following procedure: A sample was prepared by dispersing the fluoropolymer onto a segment of carbon tape that was attached to an aluminum scanning electron microscope (SEM) stub. Excess particles were blown off the carbon tape with compressed air. The sample was then sputter coated with Au/Pd for 20 seconds and was then analyzed in a Quanta 250 FEG SEM (field emission gun scanning electron microscope) under high vacuum. The accelerating voltage was set to 20.00 kV and the spot size was set to 3.0. Images were collected from three different areas on the prepared sample, and ImageJ software was used to measure the diameter of 10 fluoropolymer particles from each area for a total of 30 particle size measurements that were averaged together to determine the average particle size.

The fluoropolymer may be dispersed or solubilized in the solvent system.

The fluoropolymer may be present in the binder in amounts of at least 20% by weight, such as at least 30% by weight, such as at least 40% by weight, such as at least 50% by weight, such as at least 60% by weight, such as at least 70% by weight, such as at least 80% by weight, such as at least 85% by weight, such as at least 90% by weight, such as at least 95% by weight, such as at least 98% by weight, based on the total weight of the binder solids. The fluoropolymer may be present in the binder in amounts of no more than 99.9% by weight, such as no more than 99% by weight, such as no more than 98% by weight, such as no more than 96% by weight, such as no more than 95% by weight, such as no more than 90% by weight, such as no more than 85% by weight, such as no more than 80% by weight, based on the total weight of the binder solids. The fluoropolymer may be present in the binder in amounts of 20% to 99.9% by weight, 20% to 99% by weight, such as 20% to 98% by weight, such as 20% to 96% by weight, such as 20% to 95% by weight, such as 20% to 90% by weight, such as 20% to 85% by weight, such as 20% to 80% by weight, such as 30% to 99.9% by weight, such as 30% to 99% by weight, such as 30% to 98% by weight, such as 30% to 96% by weight, such as 30% to 95% by weight, such as 30% to 90% by weight, such as 30% to 85% by weight, such as 30% to 80% by weight, such as 40% to 99.9% by weight, such as 40% to 99% by weight, such as 40% to 98% by weight, such as 40% to 96% by weight, such as 40% to 95% by weight, such as 40% to 90% by weight, such as 40% to 85% by weight, such as 40% to 80% by weight, such as 50% to 99.9% by weight, such as 50% to 99% by weight, such as 50% to 98% by weight, such as 50% to 96% by weight, such as 50% to 95% by weight, such as 50% to 90% by weight, such as 50% to 85% by weight, such as 50% to 80% by weight, such as 60% to 99.9% by weight, such as 60% to 99% by weight, such as 60% to 98% by weight, such as 60% to 96% by weight, such as 60% to 95% by weight, such as 60% to 90% by weight, such as 60% to 85% by weight, such as 60% to 80% by weight, such as 70% to 99.9% by weight, such as 70% to 99% by weight, such as 70% to 98% by weight, such as 70% to 96% by weight, such as 70% to 95% by weight, such as 70% to 90% by weight, such as 70% to 85% by weight, such as 70% to 80% by weight, such as 80% to 99.9% by weight, such as 80% to 99% by weight, such as 80% to 98% by weight, such as 80% to 96% by weight, such as 80% to 95% by weight, such as 80% to 90% by weight, such as 80% to 85% by weight, such as 85% to 99.9% by weight, such as 85% to 99% by weight, such as 85% to 98% by weight, such as 85% to 96% by weight, such as 85% to 95% by weight, such as 85% to 90% by weight, such as 90% to 99.9% by weight, such as 90% to 99% by weight, such as 90% to 98% by weight, such as 90% to 96% by weight, such as 95% to 99.9% by weight, such as 95% to 99% by weight, such as 95% to 98% by weight, such as 95% to 96% by weight, such as 98% to 99.9% by weight, such as 98% to 99% by weight, based on the total weight of the binder solids.

The fluoropolymer may be present in the binder composition in an amount of at least 1% by weight, such as at least 5% by weight, such as at least 10% by weight, such as least 20% by weight, such as at least 25% by weight, such as at least 30% by weight, such as at least 40% by weight, based on the total weight of the binder composition. The fluoropolymer may be present in the binder composition in an amount of no more than 50% by weight, such as no more than 40% by weight, such as no more than 30% by weight, such as no more than 25% by weight, such as no more than 20% by weight, such as no more than 10% by weight, based on the total weight of the binder composition. The fluoropolymer may be present in the binder composition in an amount of 1% to 50% by weight, such as 1% to 40% by weight, such as 1% to 30% by weight, such as 1% to 25% by weight, such as 1% to 20% by weight, such as 1% to 10% by weight, such as 5% to 50% by weight, such as 5% to 40% by weight, such as 5% to 30% by weight, such as 5% to 25% by weight, such as 5% to 20% by weight, such as 5% to 10% by weight, such as 10% to 40% by weight, such as 10% to 30% by weight, such as 10% to 25% by weight, such as 10% to 20% by weight, such as 20% to 50% by weight, such as 20% to 40% by weight, such as 20% to 30% by weight, such as 20% to 25% by weight, such as 25% to 50% by weight, such as 25% to 40% by weight, such as 25% to 30% by weight, such as 30% to 50% by weight, such as 30% to 40% by weight, such as 40% to 50% by weight, based on the total weight of the binder composition.

The fluoropolymer may be present in the slurry composition in an amount of at least 0.1% by weight, such as at least 0.5% by weight, such as at least 1% by weight, such as at least 1.3% by weight, such as at least 1.9% by weight, based on the total solids weight of the slurry composition. The fluoropolymer may be present in the slurry composition in an amount of no more than 10% by weight, such as no more than 6% by weight, such as no more than 4.5% by weight, such as no more than 2.9% by weight, such as no more than 2% by weight, based on the total solids weight of the slurry composition. The fluoropolymer may be present in the slurry composition in an amount of 0.1% to 10% by weight, such as 0.1% to 6% by weight, such as 0.1% to 4.5% by weight, such as 0.1% to 2.9% by weight, such as 0.1% to 2% by weight, such as 0.5% to 10% by weight, such as 0.5% to 6% by weight, such as 0.5% to 4.5% by weight, such as 0.5% to 2.9% by weight, such as 0.5% to 2% by weight, such as 1% to 10% by weight, such as 1% to 6% by weight, such as 1% to 4.5% by weight, such as 1% to 2.9% by weight, such as 1% to 2% by weight, such as 1.3% to 10% by weight, such as 1.3% to 6% by weight, such as 1.3% to 4.5% by weight, such as 1.3% to 2.9% by weight, such as 1.3% to 2% by weight, such as 1.9% to 10% by weight, such as 1.9% to 6% by weight, such as 1.9% to 4.5% by weight, such as 1.9% to 2.9% by weight, such as 1.9% to 2% by weight, based on the total solids weight of the slurry composition.

According to the present invention, the binder composition and/or slurry composition of the present invention further comprises a solvent system comprising (i) a trialkyl phosphate; and (ii) a co-solvent comprising a lactone and/or a molecule comprising a sulfoxide and/or sulfone functional group, wherein the trialkyl phosphate and the co-solvent together comprise at least 50% by weight of the solvent system, based on the total weight of the solvent system.

As used herein, the term “solvent system” refers to the combination of solvents used in the composition. The solvent system of the present invention may comprise, consist essentially of, or consist of (i) a trialkyl phosphate, and (ii) a co-solvent comprising a lactone and/or a molecule comprising a sulfoxide and/or sulfone functional group.

The trialkyl phosphate may comprise any suitable trialkyl phosphate. For example, the trialkyl phosphate may comprise, consist essentially of, or consist of trimethyl phosphate, triethyl phosphate, tributyl phosphate, or any combination thereof.

The lactone may comprise any suitable lactone. For example, the lactone may comprise, consist essentially of, or consist of ε-caprolactone, γ-butyrolactone, or any combination thereof.

The molecule comprising a sulfoxide functional group may comprise any suitable molecule comprising a sulfoxide functional group. For example, the molecule comprising a sulfoxide functional group may comprise dimethyl sulfoxide.

The molecule comprising a sulfone functional group may comprise any suitable molecule comprising a sulfone functional group. For example, the molecule comprising a sulfone functional group may comprise tetramethylene sulfone (also known as sulfolane).

The trialkyl phosphate may be present in the solvent system in an amount of at least 0.1% by weight, such as at least 5% by weight, such as at least 10% by weight, such as at least 20% by weight, such as at least 30% by weight, such as at least 40% by weight, such as at least 50% by weight, such as at least 60% by weight, such as at least 70% by weight, such as at least 80% by weight, such as at least 90% by weight, such as at least 95% by weight, such as at least 99% by weight, based on the total weight of the solvent system. The trialkyl phosphate may be present in the solvent system in an amount of no more than 99.9% by weight, such as no more than 95% by weight, such as no more than 90% by weight, such as no more than 80% by weight, such as no more than 70% by weight, such as no more than 60% by weight, such as no more than 50% by weight, such as no more than 40% by weight, such as no more than 30% by weight, such as no more than 20% by weight, such as no more than 10% by weight, such as no more than 5% by weight, based on the total weight of the solvent system. The trialkyl phosphate may be present in the solvent system in an amount of 0.1% to 99.9% by weight, such as 5% to 99.9% by weight, such as 10% to 99.9% by weight, such as 20% to 99.9% by weight, such as 30% to 99.9% by weight, such as 40% to 99.9% by weight, such as 50% to 99.9% by weight, such as 60% to 99.9% by weight, such as 70% to 99.9% by weight, such as 80% to 99.9% by weight, such as 90% to 99.9% by weight, such as 95% to 99.9% by weight, such as 5% to 95% by weight, such as 5% to 95% by weight, such as 10% to 95% by weight, such as 20% to 95% by weight, such as 30% to 95% by weight, such as 40% to 95% by weight, such as 50% to 95% by weight, such as 60% to 95% by weight, such as 70% to 95% by weight, such as 80% to 95% by weight, such as 90% to 95% by weight, such as 0.1% to 90% by weight, such as 5% to 90% by weight, such as 10% to 90% by weight, such as 20% to 90% by weight, such as 30% to 90% by weight, such as 40% to 90% by weight, such as 50% to 90% by weight, such as 60% to 90% by weight, such as 70% to 90% by weight, such as 80% to 90% by weight, such as 0.1% to 80% by weight, such as 5% to 80% by weight, such as 10% to 80% by weight, such as 20% to 80% by weight, such as 30% to 80% by weight, such as 40% to 80% by weight, such as 50% to 80% by weight, such as 60% to 80% by weight, such as 70% to 80% by weight, such as such as 0.1% to 70% by weight, such as 5% to 70% by weight, such as 10% to 70% by weight, such as 20% to 70% by weight, such as 30% to 70% by weight, such as 40% to 70% by weight, such as 50% to 70% by weight, such as 60% to 70% by weight, such as 0.1% to 60% by weight, such as 5% to 60% by weight, such as 10% to 60% by weight, such as 20% to 60% by weight, such as 30% to 60% by weight, such as 40% to 60% by weight, such as 50% to 60% by weight, such as 0.1% to 50% by weight, such as 5% to 50% by weight, such as 10% to 50% by weight, such as 20% to 50% by weight, such as 30% to 50% by weight, such as 40% to 50% by weight, such as 0.1% to 40% by weight, such as 5% to 40% by weight, such as 10% to 40% by weight, such as 20% to 40% by weight, such as 30% to 40% by weight, such as 0.1% to 30% by weight, such as 5% to 30% by weight, such as 10% to 30% by weight, such as 20% to 30% by weight, such as 0.1% to 20% by weight, such as 5% to 20% by weight, such as 10% to 20% by weight, such as 0.1% to 10% by weight, such as 5% to 10% by weight, based on the total weight of the solvent system.

The lactone may be present in the solvent system in an amount of at least 0.1% by weight, such as at least 5% by weight, such as at least 10% by weight, such as at least 20% by weight, such as at least 30% by weight, such as at least 40% by weight, such as at least 50% by weight, such as at least 60% by weight, such as at least 70% by weight, such as at least 80% by weight, such as at least 90% by weight, such as at least 95% by weight, such as at least 99% by weight, based on the total weight of the solvent system. The lactone may be present in the solvent system in an amount of no more than 99.9% by weight, such as no more than 95% by weight, such as no more than 90% by weight, such as no more than 80% by weight, such as no more than 70% by weight, such as no more than 60% by weight, such as no more than 50% by weight, such as no more than 40% by weight, such as no more than 30% by weight, such as no more than 20% by weight, such as no more than 10% by weight, such as no more than 5% by weight, based on the total weight of the solvent system. The lactone may be present in the solvent system in an amount of 0.1% to 99.9% by weight, such as 5% to 99.9% by weight, such as 10% to 99.9% by weight, such as 20% to 99.9% by weight, such as 30% to 99.9% by weight, such as 40% to 99.9% by weight, such as 50% to 99.9% by weight, such as 60% to 99.9% by weight, such as 70% to 99.9% by weight, such as 80% to 99.9% by weight, such as 90% to 99.9% by weight, such as 95% to 99.9% by weight, such as 5% to 95% by weight, such as 5% to 95% by weight, such as 10% to 95% by weight, such as 20% to 95% by weight, such as 30% to 95% by weight, such as 40% to 95% by weight, such as 50% to 95% by weight, such as 60% to 95% by weight, such as 70% to 95% by weight, such as 80% to 95% by weight, such as 90% to 95% by weight, such as 0.1% to 90% by weight, such as 5% to 90% by weight, such as 10% to 90% by weight, such as 20% to 90% by weight, such as 30% to 90% by weight, such as 40% to 90% by weight, such as 50% to 90% by weight, such as 60% to 90% by weight, such as 70% to 90% by weight, such as 80% to 90% by weight, such as 0.1% to 80% by weight, such as 5% to 80% by weight, such as 10% to 80% by weight, such as 20% to 80% by weight, such as 30% to 80% by weight, such as 40% to 80% by weight, such as 50% to 80% by weight, such as 60% to 80% by weight, such as 70% to 80% by weight, such as such as 0.1% to 70% by weight, such as 5% to 70% by weight, such as 10% to 70% by weight, such as 20% to 70% by weight, such as 30% to 70% by weight, such as 40% to 70% by weight, such as 50% to 70% by weight, such as 60% to 70% by weight, such as 0.1% to 60% by weight, such as 5% to 60% by weight, such as 10% to 60% by weight, such as 20% to 60% by weight, such as 30% to 60% by weight, such as 40% to 60% by weight, such as 50% to 60% by weight, such as 0.1% to 50% by weight, such as 5% to 50% by weight, such as 10% to 50% by weight, such as 20% to 50% by weight, such as 30% to 50% by weight, such as 40% to 50% by weight, such as 0.1% to 40% by weight, such as 5% to 40% by weight, such as 10% to 40% by weight, such as 20% to 40% by weight, such as 30% to 40% by weight, such as 0.1% to 30% by weight, such as 5% to 30% by weight, such as 10% to 30% by weight, such as 20% to 30% by weight, such as 0.1% to 20% by weight, such as 5% to 20% by weight, such as 10% to 20% by weight, such as 0.1% to 10% by weight, such as 5% to 10% by weight, based on the total weight of the solvent system.

The molecule comprising a sulfoxide and/or sulfone functional group may be present in the solvent system in an amount of at least 0.1% by weight, such as at least 5% by weight, such as at least 10% by weight, such as at least 20% by weight, such as at least 30% by weight, such as at least 40% by weight, such as at least 50% by weight, such as at least 60% by weight, such as at least 70% by weight, such as at least 80% by weight, such as at least 90% by weight, such as at least 95% by weight, such as at least 99% by weight, based on the total weight of the solvent system. The molecule comprising a sulfoxide and/or sulfone functional group may be present in the solvent system in an amount of no more than 99.9% by weight, such as no more than 95% by weight, such as no more than 90% by weight, such as no more than 80% by weight, such as no more than 70% by weight, such as no more than 60% by weight, such as no more than 50% by weight, such as no more than 40% by weight, such as no more than 30% by weight, such as no more than 20% by weight, such as no more than 10% by weight, such as no more than 5% by weight, based on the total weight of the solvent system. The molecule comprising a sulfoxide and/or sulfone functional group may be present in the solvent system in an amount of 0.1% to 99.9% by weight, such as 5% to 99.9% by weight, such as 10% to 99.9% by weight, such as 20% to 99.9% by weight, such as 30% to 99.9% by weight, such as 40% to 99.9% by weight, such as 50% to 99.9% by weight, such as 60% to 99.9% by weight, such as 70% to 99.9% by weight, such as 80% to 99.9% by weight, such as 90% to 99.9% by weight, such as 95% to 99.9% by weight, such as 5% to 95% by weight, such as 5% to 95% by weight, such as 10% to 95% by weight, such as 20% to 95% by weight, such as 30% to 95% by weight, such as 40% to 95% by weight, such as 50% to 95% by weight, such as 60% to 95% by weight, such as 70% to 95% by weight, such as 80% to 95% by weight, such as 90% to 95% by weight, such as 0.1% to 90% by weight, such as 5% to 90% by weight, such as 10% to 90% by weight, such as 20% to 90% by weight, such as 30% to 90% by weight, such as 40% to 90% by weight, such as 50% to 90% by weight, such as 60% to 90% by weight, such as 70% to 90% by weight, such as 80% to 90% by weight, such as 0.1% to 80% by weight, such as 5% to 80% by weight, such as 10% to 80% by weight, such as 20% to 80% by weight, such as 30% to 80% by weight, such as 40% to 80% by weight, such as 50% to 80% by weight, such as 60% to 80% by weight, such as 70% to 80% by weight, such as such as 0.1% to 70% by weight, such as 5% to 70% by weight, such as 10% to 70% by weight, such as 20% to 70% by weight, such as 30% to 70% by weight, such as 40% to 70% by weight, such as 50% to 70% by weight, such as 60% to 70% by weight, such as 0.1% to 60% by weight, such as 5% to 60% by weight, such as 10% to 60% by weight, such as 20% to 60% by weight, such as 30% to 60% by weight, such as 40% to 60% by weight, such as 50% to 60% by weight, such as 0.1% to 50% by weight, such as 5% to 50% by weight, such as 10% to 50% by weight, such as 20% to 50% by weight, such as 30% to 50% by weight, such as 40% to 50% by weight, such as 0.1% to 40% by weight, such as 5% to 40% by weight, such as 10% to 40% by weight, such as 20% to 40% by weight, such as 30% to 40% by weight, such as 0.1% to 30% by weight, such as 5% to 30% by weight, such as 10% to 30% by weight, such as 20% to 30% by weight, such as 0.1% to 20% by weight, such as 5% to 20% by weight, such as 10% to 20% by weight, such as 0.1% to 10% by weight, such as 5% to 10% by weight, based on the total weight of the solvent system.

The molecule comprising a sulfoxide functional group may be present in the solvent system in an amount of at least 0.1% by weight, such as at least 5% by weight, such as at least 10% by weight, such as at least 20% by weight, such as at least 30% by weight, such as at least 40% by weight, such as at least 50% by weight, such as at least 60% by weight, such as at least 70% by weight, such as at least 80% by weight, such as at least 90% by weight, such as at least 95% by weight, such as at least 99% by weight, based on the total weight of the solvent system. The molecule comprising a sulfoxide functional group may be present in the solvent system in an amount of no more than 99.9% by weight, such as no more than 95% by weight, such as no more than 90% by weight, such as no more than 80% by weight, such as no more than 70% by weight, such as no more than 60% by weight, such as no more than 50% by weight, such as no more than 40% by weight, such as no more than 30% by weight, such as no more than 20% by weight, such as no more than 10% by weight, such as no more than 5% by weight, based on the total weight of the solvent system. The molecule comprising a sulfoxide functional group may be present in the solvent system in an amount of 0.1% to 99.9% by weight, such as 5% to 99.9% by weight, such as 10% to 99.9% by weight, such as 20% to 99.9% by weight, such as 30% to 99.9% by weight, such as 40% to 99.9% by weight, such as 50% to 99.9% by weight, such as 60% to 99.9% by weight, such as 70% to 99.9% by weight, such as 80% to 99.9% by weight, such as 90% to 99.9% by weight, such as 95% to 99.9% by weight, such as 5% to 95% by weight, such as 5% to 95% by weight, such as 10% to 95% by weight, such as 20% to 95% by weight, such as 30% to 95% by weight, such as 40% to 95% by weight, such as 50% to 95% by weight, such as 60% to 95% by weight, such as 70% to 95% by weight, such as 80% to 95% by weight, such as 90% to 95% by weight, such as 0.1% to 90% by weight, such as 5% to 90% by weight, such as 10% to 90% by weight, such as 20% to 90% by weight, such as 30% to 90% by weight, such as 40% to 90% by weight, such as 50% to 90% by weight, such as 60% to 90% by weight, such as 70% to 90% by weight, such as 80% to 90% by weight, such as 0.1% to 80% by weight, such as 5% to 80% by weight, such as 10% to 80% by weight, such as 20% to 80% by weight, such as 30% to 80% by weight, such as 40% to 80% by weight, such as 50% to 80% by weight, such as 60% to 80% by weight, such as 70% to 80% by weight, such as such as 0.1% to 70% by weight, such as 5% to 70% by weight, such as 10% to 70% by weight, such as 20% to 70% by weight, such as 30% to 70% by weight, such as 40% to 70% by weight, such as 50% to 70% by weight, such as 60% to 70% by weight, such as 0.1% to 60% by weight, such as 5% to 60% by weight, such as 10% to 60% by weight, such as 20% to 60% by weight, such as 30% to 60% by weight, such as 40% to 60% by weight, such as 50% to 60% by weight, such as 0.1% to 50% by weight, such as 5% to 50% by weight, such as 10% to 50% by weight, such as 20% to 50% by weight, such as 30% to 50% by weight, such as 40% to 50% by weight, such as 0.1% to 40% by weight, such as 5% to 40% by weight, such as 10% to 40% by weight, such as 20% to 40% by weight, such as 30% to 40% by weight, such as 0.1% to 30% by weight, such as 5% to 30% by weight, such as 10% to 30% by weight, such as 20% to 30% by weight, such as 0.1% to 20% by weight, such as 5% to 20% by weight, such as 10% to 20% by weight, such as 0.1% to 10% by weight, such as 5% to 10% by weight, based on the total weight of the solvent system.

The molecule comprising a sulfone functional group may be present in the solvent system in an amount of at least 0.1% by weight, such as at least 5% by weight, such as at least 10% by weight, such as at least 20% by weight, such as at least 30% by weight, such as at least 40% by weight, such as at least 50% by weight, such as at least 60% by weight, such as at least 70% by weight, such as at least 80% by weight, such as at least 90% by weight, such as at least 95% by weight, such as at least 99% by weight, based on the total weight of the solvent system. The molecule comprising a sulfone functional group may be present in the solvent system in an amount of no more than 99.9% by weight, such as no more than 95% by weight, such as no more than 90% by weight, such as no more than 80% by weight, such as no more than 70% by weight, such as no more than 60% by weight, such as no more than 50% by weight, such as no more than 40% by weight, such as no more than 30% by weight, such as no more than 20% by weight, such as no more than 10% by weight, such as no more than 5% by weight, based on the total weight of the solvent system. The molecule comprising a sulfone functional group may be present in the solvent system in an amount of 0.1% to 99.9% by weight, such as 5% to 99.9% by weight, such as 10% to 99.9% by weight, such as 20% to 99.9% by weight, such as 30% to 99.9% by weight, such as 40% to 99.9% by weight, such as 50% to 99.9% by weight, such as 60% to 99.9% by weight, such as 70% to 99.9% by weight, such as 80% to 99.9% by weight, such as 90% to 99.9% by weight, such as 95% to 99.9% by weight, such as 5% to 95% by weight, such as 5% to 95% by weight, such as 10% to 95% by weight, such as 20% to 95% by weight, such as 30% to 95% by weight, such as 40% to 95% by weight, such as 50% to 95% by weight, such as 60% to 95% by weight, such as 70% to 95% by weight, such as 80% to 95% by weight, such as 90% to 95% by weight, such as 0.1% to 90% by weight, such as 5% to 90% by weight, such as 10% to 90% by weight, such as 20% to 90% by weight, such as 30% to 90% by weight, such as 40% to 90% by weight, such as 50% to 90% by weight, such as 60% to 90% by weight, such as 70% to 90% by weight, such as 80% to 90% by weight, such as 0.1% to 80% by weight, such as 5% to 80% by weight, such as 10% to 80% by weight, such as 20% to 80% by weight, such as 30% to 80% by weight, such as 40% to 80% by weight, such as 50% to 80% by weight, such as 60% to 80% by weight, such as 70% to 80% by weight, such as such as 0.1% to 70% by weight, such as 5% to 70% by weight, such as 10% to 70% by weight, such as 20% to 70% by weight, such as 30% to 70% by weight, such as 40% to 70% by weight, such as 50% to 70% by weight, such as 60% to 70% by weight, such as 0.1% to 60% by weight, such as 5% to 60% by weight, such as 10% to 60% by weight, such as 20% to 60% by weight, such as 30% to 60% by weight, such as 40% to 60% by weight, such as 50% to 60% by weight, such as 0.1% to 50% by weight, such as 5% to 50% by weight, such as 10% to 50% by weight, such as 20% to 50% by weight, such as 30% to 50% by weight, such as 40% to 50% by weight, such as 0.1% to 40% by weight, such as 5% to 40% by weight, such as 10% to 40% by weight, such as 20% to 40% by weight, such as 30% to 40% by weight, such as 0.1% to 30% by weight, such as 5% to 30% by weight, such as 10% to 30% by weight, such as 20% to 30% by weight, such as 0.1% to 20% by weight, such as 5% to 20% by weight, such as 10% to 20% by weight, such as 0.1% to 10% by weight, such as 5% to 10% by weight, based on the total weight of the solvent system.

The trialkyl phosphate and the co-solvent together may comprise at least 50% by weight of the solvent system, such as at least 60% by weight, such as at least 70% by weight, such as at least 80% by weight, such as at least 90% by weight, such as at least 95% by weight, such as 100% by weight, based on the total weight of the solvent system.

The trialkyl phosphate and the lactone together may comprise at least 50% by weight of the solvent system, such as at least 60% by weight, such as at least 70% by weight, such as at least 80% by weight, such as at least 90% by weight, such as at least 95% by weight, such as 100% by weight, based on the total weight of the solvent system.

The trialkyl phosphate and the molecule comprising a sulfoxide and/or sulfone functional group together may comprise at least 50% by weight of the solvent system, such as at least 60% by weight, such as at least 70% by weight, such as at least 80% by weight, such as at least 90% by weight, such as at least 95% by weight, such as 100% by weight, based on the total weight of the solvent system.

The trialkyl phosphate and the molecule comprising a sulfoxide functional group together may comprise at least 50% by weight of the solvent system, such as at least 60% by weight, such as at least 70% by weight, such as at least 80% by weight, such as at least 90% by weight, such as at least 95% by weight, such as 100% by weight, based on the total weight of the solvent system.

The trialkyl phosphate and the molecule comprising a sulfone functional group together may comprise at least 50% by weight of the solvent system, such as at least 60% by weight, such as at least 70% by weight, such as at least 80% by weight, such as at least 90% by weight, such as at least 95% by weight, such as 100% by weight, based on the total weight of the solvent system.

The fluoropolymer of the binder composition and/or slurry composition may be solubilized in the solvent system at room temperature, i.e., about 23° C., and atmospheric (1 atm or 1.01 bar) pressure.

The solvent system may be present in the binder composition in an amount of at least 50% by weight, such as at least 60% by weight, such as at least 75% by weight, such as at least 80% by weight, such as at least 90% by weight, such as at least 95% by weight, such as at least 99% by weight, based on the total weight of the binder composition. The solvent system may be present in the binder composition in an amount of no more than 99% by weight, such as no more than 95% by weight, such as no more than 90% by weight, such as no more than 80% by weight, such as no more than 75% by weight, such as no more than 70% by weight, such as no more than 60% by weight, such as no more than 50% by weight, based on the total weight of the binder composition. The solvent system may be present in the binder composition in an amount of 50% to 99% by weight, such as 60% to 99% by weight, such as 75% to 99% by weight, such as 80% to 99% by weight, such as 90% to 99% by weight, such as 95% to 99% by weight, such as 50% to 95% by weight, such as 60% to 95% by weight, such as 75% to 95% by weight, such as 80% to 95% by weight, such as 90% to 95% by weight, such as 50% to 90% by weight, such as 60% to 90% by weight, such as 75% to 90% by weight, such as 80% to 90% by weight, such as 50% to 80% by weight, such as 60% to 80% by weight, such as 75% to 80% by weight, such as 50% to 75% by weight, such as 60% to 75% by weight, such as 50% to 60% by weight, based on the total weight of the binder composition.

The solvent system may be present in the slurry composition in an amount of at least 1% by weight, such as at least 10% by weight, such as at least 15% by weight, such as at least 20% by weight, such as at least 30% by weight, such as at least 35% by weight, based on the total weight of the slurry composition. The solvent system may be present in an amount of no more than 90% by weight, such as no more than 80% by weight, such as no more than 60% by weight, such as no more than 50% by weight, such as no more than 40% by weight, such as no more than 35% by weight, such as no more than 30% by weight, such as no more than 25% by weight, based on the total weight of the slurry composition. The solvent system may be present in an amount of such as 1% to 90% by weight, such as 1% to 80% by weight, such as 1% to 60% by weight, such as 1% to 50% by weight, such as 1% to 40% by weight, such as 1% to 35% by weight, such as 1% to 30% by weight, such as 1% to 25% by weight, such as 10% to 90% by weight, such as 10% to 80% by weight, such as 10% to 60% by weight, such as 10% to 50% by weight, such as 10% to 40% by weight, such as 10% to 35% by weight, such as 10% to 30% by weight, such as 10% to 25% by weight, 15% to 90% by weight, such as 15% to 80% by weight, such as 15% to 60% by weight, such as 15% to 50% by weight, such as 15% to 40% by weight, such as 15% to 35% by weight, such as 15% to 30% by weight, such as 15% to 25% by weight, such as 20% to 90% by weight, such as 20% to 80% by weight, such as 20% to 60% by weight, such as 20% to 50% by weight, such as 20% to 40% by weight, such as 20% to 35% by weight, such as 20% to 30% by weight, such as 20% to 25% by weight, such as 30% to 90% by weight, such as 30% to 80% by weight, such as 30% to 60% by weight, such as 30% to 50% by weight, such as 30% to 40% by weight, such as 30% to 35% by weight, such as 35% to 90% by weight, such as 35% to 80% by weight, such as 35% to 60% by weight, such as 35% to 50% by weight, such as 35% to 40% by weight, based on the total weight of the slurry composition.

The binder composition and/or slurry composition may optionally further comprise a dispersant. The dispersant may assist in stabilizing and/or dispersing the components of the binder and/or slurry composition. The dispersant may comprise polyvinyl pyrrolidone, an addition polymer, and/or a polyacrylate, as well as commercially available dispersants such as DISPERBYK-102, DISPERBYK-109, DISPERBYK-2055, DISPERBYK-2155, DISPERBYK-2159, and DISPERBYK-2200, each commercially available from BYK.

The polyvinyl pyrrolidone may have a weight average molecular weight of at least 2,000 g/mol, such as at least 4,000 g/mol, such as at least 6,000 g/mol, such as at least 8,000 g/mol. The polyvinyl pyrrolidone may have a weight average molecular weight of no more than 3,000,000 g/mol, such as no more than 1,700,000 g/mol, such as no more than 500,000 g/mol, such as no more than 80,000 g/mol, such as no more than 40,000 g/mol, such as no more than 20,000 g/mol. The polyvinyl pyrrolidone may have a weight average molecular weight of 2,000 to 3,000,000 g/mol, such as 2,000 to 1,700,000 g/mol, such as 2,000 to 500,000 g/mol, such as 2,000 to 80,000 g/mol, such as 2,000 to 40,000 g/mol, such as 2,000 to 20,000 g/mol, such as 4,000 to 3,000,000 g/mol, such as 4,000 to 1,700,000 g/mol, such as 4,000 to 500,000 g/mol, such as 4,000 to 80,000 g/mol, such as 4,000 to 40,000 g/mol, such as 4,000 to 20,000 g/mol, such as 6,000 to 3,000,000 g/mol, such as 6,000 to 1,700,000 g/mol, such as 6,000 to 500,000 g/mol, such as 6,000 to 80,000 g/mol, such as 6,000 to 40,000 g/mol, such as 6,000 to 20,000 g/mol, such as 6,000 to 3,000,000 g/mol, such as 6,000 to 1,700,000 g/mol, such as 6,000 to 500,000 g/mol, such as 6,000 to 80,000 g/mol, such as 6,000 to 40,000 g/mol, such as 6,000 to 20,000 g/mol, such as 8,000 to 3,000,000 g/mol, such as 8,000 to 1,700,000 g/mol, such as 8,000 to 500,000 g/mol, such as 8,000 to 80,000 g/mol, such as 8,000 to 40,000 g/mol, such as 8,000 to 20,000 g/mol.

The dispersant may be present in the binder in amounts of at least 0.1% by weight, such as at least 1% by weight, such as at least 2% by weight, such as at least 3% by weight, such as at least 4% by weight, such as at least 5% by weight, such as at least 8% by weight, based on the total weight of the binder solids. The dispersant may be present in the binder in amounts of no more than 25% by weight, such as no more than 20% by weight, such as no more than 15% by weight, such as no more than 12.5% by weight, such as no more than 10% by weight, such as no more than 5% by weight, based on the total weight of the binder solids. The dispersant may be present in the binder in amounts of 0.1% to 25% by weight, such as 0.1% to 20% by weight, such as 0.1% to 15% by weight, such as 0.1% to 12.5% by weight, such as 0.1% to 10% by weight, such as 0.1% to 5% by weight, such as 1% to 25% by weight, such as 1% to 20% by weight, such as 1% to 15% by weight, such as 1% to 12.5% by weight, such as 1% to 10% by weight, such as 1% to 5% by weight, such as 2% to 25% by weight, such as 2% to 20% by weight, such as 2% to 15% by weight, such as 2% to 12.5% by weight, such as 2% to 10% by weight, such as 2% to 5% by weight, such as 3% to 25% by weight, such as 3% to 20% by weight, such as 3% to 15% by weight, such as 3% to 12.5% by weight, such as 3% to 10% by weight, such as 3% to 5% by weight, such as 4% to 25% by weight, such as 4% to 20% by weight, such as 4% to 15% by weight, such as 4% to 12.5% by weight, such as 4% to 10% by weight, such as 4% to 5% by weight, such as 5% to 25% by weight, such as 5% to 20% by weight, such as 5% to 15% by weight, such as 5% to 12.5% by weight, such as 5% to 10% by weight, such as 8% to 25% by weight, such as 8% to 20% by weight, such as 8% to 15% by weight, such as 8% to 12.5% by weight, such as 8% to 10% by weight, based on the total weight of the binder solids.

The dispersant may be present in the slurry composition in an amount of at least 0.1% by weight, such as at least 0.3% by weight, such as at least 0.5% by weight, such as at least 0.7% by weight, such as at least 0.8% by weight, based on the total solids weight of the slurry composition. The dispersant may be present in the slurry composition in an amount of no more than 5% by weight, such as no more than 3% by weight, such as no more than 2% by weight, such as no more than 1% by weight, such as no more than 0.8% by weight, based on the total solids weight of the slurry composition. The dispersant may be present in the slurry composition in an amount of 0.1% to 5% by weight, such as 0.1% to 3% by weight, such as 0.1% to 2% by weight, such as 0.1% to 1% by weight, such as 0.1% to 0.8% by weight, such as 0.3% to 5% by weight, such as 0.3% to 3% by weight, such as 0.3% to 2% by weight, such as 0.3% to 1% by weight, such as 0.3% to 0.8% by weight, such as 0.5% to 5% by weight, such as 0.5% to 3% by weight, such as 0.5% to 2% by weight, such as 0.5% to 1% by weight, such as 0.5% to 0.8% by weight, such as 0.7% to 5% by weight, such as 0.7% to 3% by weight, such as 0.7% to 2% by weight, such as 0.7% to 1% by weight, such as 0.7% to 0.8% by weight, such as 0.8% to 5% by weight, such as 0.8% to 3% by weight, such as 0.8% to 2% by weight, such as 0.8% to 1% by weight, based on the total solids weight of the slurry composition.

The binder composition and/or slurry composition may optionally further comprise an addition polymer. The addition polymer may comprise constitutional units comprising the residue of one or more ethylenically unsaturated monomers. The addition polymer may be prepared by polymerizing a reaction mixture of alpha, beta-ethylenically unsaturated monomers that comprise one or more ethylenically unsaturated monomers. The addition polymer may be in the form of a block polymer, a random polymer, or a gradient polymer.

The addition polymer may comprise the constitutional units comprising the residue of, or be derived from, alkyl esters of (meth)acrylic acid, ethylenically unsaturated monomers comprising one or more active hydrogen groups, ethylenically unsaturated monomers comprising a heterocyclic group, ethylenically unsaturated monomers comprising a silicon-containing functional group, as well as other ethylenically unsaturated monomers. The addition polymer may comprise a functional group, and the functional group may be post-reacted with another compound. For example, epoxy functional groups on the resulting addition polymer incorporated through an epoxy functional monomer (e.g., glycidyl (meth)acrylate) may be post-reacted with a hydroxy-functional acid, such as a beta-hydroxy functional acid such as citric acid, tartaric acid, and/or 3-hydroxy-2-naphthoic acid, to result in hydroxyl functional groups on the addition polymer.

The addition polymer may optionally comprise a silicon-containing functional group. As used herein, a “silicon-containing functional group” refers to an organosilicon group bound to the polymer backbone that comprises organic substituents. The silicon-containing functional group comprises at least one alkoxy substituent and may be represented by the general formula —SiR¹ₐX₃₋ₐ wherein R¹ represents a substituted or unsubstituted hydrocarbon group with 1 to 20 carbon atoms, each X independently represents a hydroxyl group or a hydrolysable group wherein at least one X is an alkoxy group, and a is 0, 1, or 2. Accordingly, the silicon-containing functional group may comprise one alkoxy substituent, two alkoxy substituents, three alkoxy substituents, or any combination thereof, and the addition polymer may comprise an ethylenically unsaturated monomer comprising a silicon-containing functional group comprising one alkoxy substituent, a silicon-containing functional group comprising two alkoxy substituents, a silicon-containing functional group comprising three alkoxy substituents, or any combination thereof.

The silicon-containing functional group may be included in the addition polymer as an ethylenically unsaturated monomer comprising a silicon-containing functional group included during polymerization of the addition polymer. The addition polymer may comprise constitutional units comprising the residue of an ethylenically unsaturated monomer comprising a silicon-containing functional group comprising at least one alkoxy substituent. The addition polymer may comprise constitutional units comprising the residue of an ethylenically unsaturated monomer comprising a silicon-containing functional group comprising at least one alkoxy substituent in an amount of at least 0.5% by weight, such as at least 1% by weight, such as at least 5% by weight, such as at least 10% by weight, such as at least 20% by weight, such as at least 30% by weight, such as at least 40% by weight, such as at least 50% by weight, such as at least 60% by weight, such as at least 70% by weight, such as at least 80% by weight, such as at least 90% by weight, based on the total weight of the addition polymer. The addition polymer may comprise constitutional units comprising the residue of an ethylenically unsaturated monomer comprising a silicon-containing functional group comprising at least one alkoxy substituent in an amount of 100% by weight, such as no more than 90% by weight, such as no more than 80% by weight, such as no more than 70% by weight, such as no more than 60% by weight, such as no more than 50% by weight, such as no more than 40% by weight, such as no more than 30% by weight, such as no more than 20% by weight, such as no more than 10% by weight, such as no more than 5% by weight, based on the total weight of the addition polymer. The addition polymer may comprise constitutional units comprising the residue of an ethylenically unsaturated monomer comprising a silicon-containing functional group comprising at least one alkoxy substituent in an amount of 0.5% to 100% by weight, such as 1% to 100% by weight, such as 5% to 100% by weight, such as 10% to 100% by weight, such as 20% to 100% by weight, such as 30% to 100% by weight, such as 40% to 100% by weight, such as 50% to 100% by weight, such as 60% to 100% by weight, such as 70% to 100% by weight, such as 80% to 100% by weight, such as 90% to 100% by weight, such as 0.5% to 90% by weight, such as 1% to 90% by weight, such as 5% to 90% by weight, such as 10% to 90% by weight, such as 20% to 90% by weight, such as 30% to 90% by weight, such as 40% to 90% by weight, such as 50% to 90% by weight, such as 60% to 90% by weight, such as 70% to 90% by weight, such as 80% to 90% by weight, such as 0.5% to 80% by weight, such as 1% to 80% by weight, such as 5% to 80% by weight, such as 10% to 80% by weight, such as 20% to 80% by weight, such as 30% to 80% by weight, such as 40% to 80% by weight, such as 50% to 80% by weight, such as 60% to 80% by weight, such as 70% to 80% by weight, such as 0.5% to 70% by weight, such as 1% to 70% by weight, such as 5% to 70% by weight, such as 10% to 70% by weight, such as 20% to 70% by weight, such as 30% to 70% by weight, such as 40% to 70% by weight, such as 50% to 70% by weight, such as 60% to 70% by weight, such as 0.5% to 60% by weight, such as 1% to 60% by weight, such as 5% to 60% by weight, such as 10% to 60% by weight, such as 20% to 60% by weight, such as 30% to 60% by weight, such as 40% to 60% by weight, such as 50% to 60% by weight, such as 0.5% to 50% by weight, such as 1% to 50% by weight, such as 5% to 50% by weight, such as 10% to 50% by weight, such as 20% to 50% by weight, such as 30% to 50% by weight, such as 40% to 50% by weight, such as 0.5% to 40% by weight, such as 1% to 40% by weight, such as 5% to 40% by weight, such as 10% to 40% by weight, such as 20% to 40% by weight, such as 30% to 40% by weight, such as 0.5% to 30% by weight, such as 1% to 30% by weight, such as 5% to 30% by weight, such as 10% to 30% by weight, such as 20% to 30% by weight, such as 0.5% to 20% by weight, such as 1% to 20% by weight, such as 5% to 20% by weight, such as 10% to 20% by weight, such as 0.5% to 10% by weight, such as 1% to 10% by weight, such as 5% to 10% by weight, such as 0.5% to 5% by weight, such as 1% to 5% by weight, based on the total weight of the addition polymer. The addition polymer may be derived from a reaction mixture comprising the ethylenically unsaturated monomer comprising a silicon-containing functional group comprising at least one alkoxy substituent in an amount of 0.5% to 100% by weight, such as 1% to 100% by weight, such as 5% to 100% by weight, such as 10% to 100% by weight, such as 20% to 100% by weight, such as 30% to 100% by weight, such as 40% to 100% by weight, such as 50% to 100% by weight, such as 60% to 100% by weight, such as 70% to 100% by weight, such as 80% to 100% by weight, such as 90% to 100% by weight, such as 0.5% to 90% by weight, such as 1% to 90% by weight, such as 5% to 90% by weight, such as 10% to 90% by weight, such as 20% to 90% by weight, such as 30% to 90% by weight, such as 40% to 90% by weight, such as 50% to 90% by weight, such as 60% to 90% by weight, such as 70% to 90% by weight, such as 80% to 90% by weight, such as 0.5% to 80% by weight, such as 1% to 80% by weight, such as 5% to 80% by weight, such as 10% to 80% by weight, such as 20% to 80% by weight, such as 30% to 80% by weight, such as 40% to 80% by weight, such as 50% to 80% by weight, such as 60% to 80% by weight, such as 70% to 80% by weight, such as 0.5% to 70% by weight, such as 1% to 70% by weight, such as 5% to 70% by weight, such as 10% to 70% by weight, such as 20% to 70% by weight, such as 30% to 70% by weight, such as 40% to 70% by weight, such as 50% to 70% by weight, such as 60% to 70% by weight, such as 0.5% to 60% by weight, such as 1% to 60% by weight, such as 5% to 60% by weight, such as 10% to 60% by weight, such as 20% to 60% by weight, such as 30% to 60% by weight, such as 40% to 60% by weight, such as 50% to 60% by weight, such as 0.5% to 50% by weight, such as 1% to 50% by weight, such as 5% to 50% by weight, such as 10% to 50% by weight, such as 20% to 50% by weight, such as 30% to 50% by weight, such as 40% to 50% by weight, such as 0.5% to 40% by weight, such as 1% to 40% by weight, such as 5% to 40% by weight, such as 10% to 40% by weight, such as 20% to 40% by weight, such as 30% to 40% by weight, such as 0.5% to 30% by weight, such as 1% to 30% by weight, such as 5% to 30% by weight, such as 10% to 30% by weight, such as 20% to 30% by weight, such as 0.5% to 20% by weight, such as 1% to 20% by weight, such as 5% to 20% by weight, such as 10% to 20% by weight, such as 0.5% to 10% by weight, such as 1% to 10% by weight, such as 5% to 10% by weight, such as 0.5% to 5% by weight, such as 1% to 5% by weight, based on the total weight of polymerizable monomers used in the reaction mixture.

The silicon-containing functional group may alternatively be included in the addition polymer through a post-polymerization addition to the addition polymer. The addition polymer may be polymerized to comprise functional groups that could be post-reacted with a silicon-containing functional group containing compound to introduce the silicon-containing functional group into the addition polymer. For example, the addition polymer may be polymerized to include epoxide functional groups that could be post-reacted with, for example, an aminosilane, or the addition polymer may be polymerized to include hydroxyl functional groups that can be post-reacted with an isocyanato-functional silane, among other methods of incorporation.

The addition polymer may have a silicon-containing functional group equivalent weight of such as at least 500 g/eq, such as at least 750 g/eq, such as at least 1,000 g/eq, such as at least 1,200 g/eq, such as at least 1,500 g/eq, such as at least 2,500 g/eq, such as at least 5,000 g/eq. The addition polymer may have a silicon-containing functional group equivalent weight of no more than 50,000 g/eq, such as no more than 25,000 g/eq, such as no more than 15,000 g/eq, such as no more than 10,000 g/eq, such as no more than 5,000 g/eq, such as no more than 2,500 g/eq, such as no more than 2,000 g/eq. The addition polymer may have a silicon-containing functional group equivalent weight of 500 to 50,000 g/eq, such as 500 to 25,000 g/eq, such as 500 to 15,000 g/eq, such as 500 to 10,000 g/eq, such as 500 to 5,000 g/eq, such as 500 to 2,500 g/eq, such as 500 to 2,000 g/eq, such as 750 to 50,000 g/eq, such as 750 to 25,000 g/eq, such as 750 to 15,000 g/eq, such as 750 to 10,000 g/eq, such as 750 to 5,000 g/eq, such as 750 to 2,500 g/eq, such as 750 to 2,000 g/eq, such as 1,000 to 50,000 g/eq, such as 1,000 to 25,000 g/eq, such as 1,000 to 15,000 g/eq, such as 1,000 to 10,000 g/eq, such as 1,000 to 5,000 g/eq, such as 1,000 to 2,500 g/eq, such as 1,000 to 2,000 g/eq, such as 1,200 to 50,000 g/eq, such as 1,200 to 25,000 g/eq, such as 1,200 to 15,000 g/eq, such as 1,200 to 10,000 g/eq, such as 1,200 to 5,000 g/eq, such as 1,200 to 2,500 g/eq, such as 1,200 to 2,000 g/eq, such as 1,500 to 50,000 g/eq, such as 1,500 to 25,000 g/eq, such as 1,500 to 15,000 g/eq, such as 1,500 to 10,000 g/eq, such as 1,500 to 5,000 g/eq, such as 1,500 to 2,500 g/eq, such as 1,500 to 2,000 g/eq. 2,500 to 50,000 g/eq, such as 2,500 to 25,000 g/eq, such as 2,500 to 15,000 g/eq, such as 2,500 to 10,000 g/eq, such as 2,500 to 5,000 g/eq, such as 5,000 to 50,000 g/eq, such as 5,000 to 25,000 g/eq, such as 5,000 to 15,000 g/eq, such as 5,000 to 10,000 g/eq. As used herein, the silicon-containing functional group equivalent weight refers to a theoretical value determined by dividing the total theoretical weight of the addition polymer by the total number of equivalents of silicon-containing groups theoretically present therein.

The addition polymer comprising the silicon-containing functional group may have an alkoxy equivalent weight of at least 75 g/eq, such as at least 100 g/eq, such as at least 250 g/eq, such as at least 500 g/eq, such as at least 750 g/eq, such as at least 1,000 g/eq, such as at least 1,200 g/eq, such as at least 1,500 g/eq, such as at least 2,000 g/eq. The addition polymer comprising the silicon-containing functional group may have an alkoxy equivalent weight of no more than 15,000 g/eq, such as no more than 10,000 g/eq, such as no more than 7,500 g/eq, such as no more than 5,000 g/eq, such as no more than 2.500 g/eq, such as no more than 2,000 g/eq. such as no more than 1,500 g/eq, such as no more than 1,000 g/eq, such as no more than 750 g/eq, such as no more than 600 g/eq, such as no more than 500 g/eq. The addition polymer comprising the silicon-containing functional group may have an alkoxy equivalent weight of 75 to 15,000 g/eq, such as 75 to 10,000 g/eq, such as 75 to 7,500 g/eq, such as 75 to 5,000 g/eq, such as 75 to 2.500 g/eq, such as 75 to 2,000 g/eq, such as 75 to 1,500 g/eq, such as 75 to 1,000 g/eq, such as 75 to 750 g/eq, such as 75 to 600 g/eq, such as 75 to 500 g/eq, such as 100 to 15,000 g/eq, such as 100 to 10,000 g/eq, such as 100 to 7,500 g/eq, such as 100 to 5,000 g/eq, such as 100 to 2,500 g/eq, such as 100 to 2,000 g/eq, such as 100 to 1,500 g/eq, such as 100 to 1,000 g/eq, such as 100 to 750 g/eq, such as 100 to 600 g/eq, such as 100 to 500 g/eq, such as 250 to 15,000 g/eq, such as 250 to 10,000 g/eq, such as 250 to 7,500 g/eq, such as 250 to 5,000 g/eq, such as 250 to 2,500 g/eq, such as 250 to 2,000 g/eq, such as 250 to 1,500 g/eq, such as 250 to 1,000 g/eq, such as 250 to 750 g/eq, such as 250 to 600 g/eq, such as 250 to 500 g/eq, such as 500 to 15,000 g/eq, such as 500 to 10,000 g/eq, such as 500 to 7,500 g/eq, such as 500 to 5,000 g/eq, such as 500 to 2,500 g/eq, such as 500 to 2,000 g/eq, such as 500 to 1,500 g/eq, such as 500 to 1,000 g/eq, such as 500 to 750 g/eq, such as 500 to 600 g/eq, such as 750 to 15,000 g/eq, such as 750 to 10,000 g/eq, such as 750 to 7,500 g/eq, such as 750 to 5,000 g/eq, such as 750 to 2,500 g/eq, such as 750 to 2,000 g/eq, such as 750 to 1,500 g/eq, such as 750 to 1,000 g/eq, such as 1,000 to 15,000 g/eq, such as 1,000 to 10,000 g/eq, such as 1,000 to 7,500 g/eq, such as 1,000 to 5,000 g/eq, such as 1,000 to 2,500 g/eq, such as 1,000 to 2,000 g/eq, such as 1,000 to 1,500 g/eq, such as 1,200 to 15,000 g/eq, such as 1,200 to 10,000 g/eq, such as 1,200 to 7,500 g/eq, such as 1,200 to 5,000 g/eq, such as 1,200 to 2,500 g/eq, such as 1,200 to 2,000 g/eq, such as 1,200 to 1,500 g/eq, such as 1,500 to 15,000 g/eq, such as 1,500 to 10,000 g/eq, such as 1,500 to 7,500 g/eq, such as 1,500 to 5,000 g/eq, such as 1,500 to 2,500 g/eq, such as 1,500 to 2,000 g/eq, such as 2,000 to 15,000 g/eq, such as 2,000 to 10,000 g/eq, such as 2,000 to 7,500 g/eq, such as 2,000 to 5,000 g/eq, such as 2,000 to 2,500 g/eq. As used herein, the alkoxy equivalent weight refers to a theoretical value determined by dividing the total theoretical weight of the addition polymer by the total number of equivalents of alkoxy groups theoretically present therein.

The addition polymer may optionally comprise constitutional units comprising the residue of an alkyl esters of (meth)acrylic acid containing from 1 to 18 carbon atoms in the alkyl group, such as 1 to 10 carbon atoms in the alkyl group. Non-limiting examples of alkyl esters of (meth)acrylic acid containing from 1 to 18 carbon atoms in the alkyl group include methyl (meth)acrylate, ethyl (meth)acrylate, butyl (meth)acrylate, hexyl (meth)acrylate, octyl (meth)acrylate, isodecyl (meth)acrylate, stearyl (meth)acrylate, 2-ethylhexyl (meth)acrylate, decyl (meth)acrylate and dodecyl (meth)acrylate. The constitutional units comprising the residue of the alkyl esters of (meth)acrylic acid containing from 1 to 18 carbon atoms in the alkyl group may comprise at least 30% by weight, such as at least 35% by weight, such as at least 40% by weight, such as at least 45% by weight, such as at least 47.5% by weight, based on the total weight of the addition polymer. The constitutional units comprising the residue of the alkyl esters of (meth)acrylic acid containing from 1 to 18 carbon atoms in the alkyl group may comprise no more than 96%, such as no more than 90%, such as no more than 85%, such as no more than 80%, such as no more than 75%, such as no more than 70%, such as no more than 65%, based on the total weight of the addition polymer. The constitutional units comprising the residue of the alkyl esters of (meth)acrylic acid containing from 1 to 18 carbon atoms in the alkyl group may comprise 30% to 96% by weight, such as 30% to 90% by weight, such as 30% to 85% by weight, such as 30% to 80% by weight, such as 30% to 75% by weight, such as 30% to 70% by weight, such as 30% to 65% by weight, such as 35% to 96% by weight, such as 35% to 90% by weight, such as 35% to 85% by weight, such as 35% to 80% by weight, such as 35% to 75% by weight, such as 35% to 70% by weight, such as 35% to 65% by weight, such as 40% to 96% by weight, such as 40% to 90% by weight, such as 40% to 85% by weight, such as 40% to 80% by weight, such as 40% to 75% by weight, such as 40% to 70% by weight, such as 40% to 65% by weight, such as 45% to 96% by weight, such as 45% to 90% by weight, such as 45% to 85% by weight, such as 45% to 80% by weight, such as 45% to 75% by weight, such as 45% to 70% by weight, such as 45% to 65% by weight, such as 47.5% to 96% by weight, such as 47.5% to 90% by weight, such as 47.5% to 85% by weight, such as 47.5% to 80% by weight, such as 47.5% to 75% by weight, such as 47.5% to 70% by weight, such as 47.5% to 65% by weight, based on the total weight of the addition polymer. The addition polymer may be derived from a reaction mixture comprising the alkyl esters of (meth)acrylic acid containing from 1 to 18 carbon atoms in the alkyl group in an amount of 30% to 96% by weight, such as 30% to 90% by weight, such as 30% to 85% by weight, such as 30% to 80% by weight, such as 30% to 75% by weight, such as 30% to 70% by weight, such as 30% to 65% by weight, such as 35% to 96% by weight, such as 35% to 90% by weight, such as 35% to 85% by weight, such as 35% to 80% by weight, such as 35% to 75% by weight, such as 35% to 70% by weight, such as 35% to 65% by weight, such as 40% to 96% by weight, such as 40% to 90% by weight, such as 40% to 85% by weight, such as 40% to 80% by weight, such as 40% to 75% by weight, such as 40% to 70% by weight, such as 40% to 65% by weight, such as 45% to 96% by weight, such as 45% to 90% by weight, such as 45% to 85% by weight, such as 45% to 80% by weight, such as 45% to 75% by weight, such as 45% to 70% by weight, such as 45% to 65% by weight, such as 47.5% to 96% by weight, such as 47.5% to 90% by weight, such as 47.5% to 85% by weight, such as 47.5% to 80% by weight, such as 47.5% to 75% by weight, such as 47.5% to 70% by weight, such as 47.5% to 65% by weight, based on the total weight of polymerizable monomers used in the reaction mixture.

The alkyl esters of (meth)acrylic acid containing from 1 to 18 carbon atoms in the alkyl group may comprise an alkyl ester of (meth)acrylic acid containing from 1 to 3 carbon atoms in the alkyl group such that the addition polymer optionally comprises constitutional units comprising the residue of an alkyl ester of (meth)acrylic acid containing from 1 to 3 carbon atoms in the alkyl group. Non-limiting examples of alkyl esters of (meth)acrylic acid containing from 1 to 3 carbon atoms in the alkyl group include methyl (meth)acrylate and ethyl (meth)acrylate. The constitutional units comprising the residue of the alkyl esters of (meth)acrylic acid containing from 1 to 3 carbon atoms in the alkyl group may comprise at least 30% by weight, such as at least 35% by weight, such as at least 40% by weight, such as at least 45% by weight, such as at least 47.5% by weight, based on the total weight of the respective polymer. The constitutional units comprising the residue of the alkyl esters of (meth)acrylic acid containing from 1 to 3 carbon atoms in the alkyl group may comprise no more than 96%, such as no more than 90%, such as no more than 85%, such as no more than 80%, such as no more than 75%, such as no more than 70%, such as no more than 65%, based on the total weight of the respective polymer. The constitutional units comprising the residue of the alkyl esters of (meth)acrylic acid containing from 1 to 3 carbon atoms in the alkyl group may comprise 30% to 96% by weight, such as 30% to 90% by weight, such as 30% to 85% by weight, such as 30% to 80% by weight, such as 30% to 75% by weight, such as 30% to 70% by weight, such as 30% to 65% by weight, such as 35% to 96% by weight, such as 35% to 90% by weight, such as 35% to 85% by weight, such as 35% to 80% by weight, such as 35% to 75% by weight, such as 35% to 70% by weight, such as 35% to 65% by weight, such as 40% to 96% by weight, such as 40% to 90% by weight, such as 40% to 85% by weight, such as 40% to 80% by weight, such as 40% to 75% by weight, such as 40% to 70% by weight, such as 40% to 65% by weight, such as 45% to 96% by weight, such as 45% to 90% by weight, such as 45% to 85% by weight, such as 45% to 80% by weight, such as 45% to 75% by weight, such as 45% to 70% by weight, such as 45% to 65% by weight, such as 47.5% to 96% by weight, such as 47.5% to 90% by weight, such as 47.5% to 85% by weight, such as 47.5% to 80% by weight, such as 47.5% to 75% by weight, such as 47.5% to 70% by weight, such as 47.5% to 65% by weight, based on the total weight of the respective polymer. The addition polymer may be derived from a reaction mixture comprising the alkyl esters of (meth)acrylic acid containing from 1 to 3 carbon atoms in the alkyl group in an amount of 30% to 96% by weight, such as 30% to 90% by weight, such as 30% to 85% by weight, such as 30% to 80% by weight, such as 30% to 75% by weight, such as 30% to 70% by weight, such as 30% to 65% by weight, such as 35% to 96% by weight, such as 35% to 90% by weight, such as 35% to 85% by weight, such as 35% to 80% by weight, such as 35% to 75% by weight, such as 35% to 70% by weight, such as 35% to 65% by weight, such as 40% to 96% by weight, such as 40% to 90% by weight, such as 40% to 85% by weight, such as 40% to 80% by weight, such as 40% to 75% by weight, such as 40% to 70% by weight, such as 40% to 65% by weight, such as 45% to 96% by weight, such as 45% to 90% by weight, such as 45% to 85% by weight, such as 45% to 80% by weight, such as 45% to 75% by weight, such as 45% to 70% by weight, such as 45% to 65% by weight, such as 47.5% to 96% by weight, such as 47.5% to 90% by weight, such as 47.5% to 85% by weight, such as 47.5% to 80% by weight, such as 47.5% to 75% by weight, such as 47.5% to 70% by weight, such as 47.5% to 65% by weight, based on the total weight of polymerizable monomers used in the reaction mixture for each respective polymer.

The alkyl esters of (meth)acrylic acid containing from 1 to 18 carbon atoms in the alkyl group may comprise an alkyl ester of (meth)acrylic acid containing from 4 to 18 carbon atoms in the alkyl group such that the addition polymer optionally comprises constitutional units comprising the residue of an alkyl ester of (meth)acrylic acid containing from 4 to 18 carbon atoms in the alkyl group. Non-limiting examples of alkyl esters of (meth)acrylic acid containing from 4 to 18 carbon atoms in the alkyl group include butyl (meth)acrylate, hexyl (meth)acrylate, octyl (meth)acrylate, isodecyl (meth)acrylate, stearyl (meth)acrylate, 2-ethylhexyl (meth)acrylate, decyl (meth)acrylate and dodecyl (meth)acrylate. The constitutional units comprising the residue of the alkyl esters of (meth)acrylic acid containing from 4 to 18 carbon atoms in the alkyl group may comprise at least 2% by weight, such as at least 5% by weight, such as at least 10% by weight, such as at least 15% by weight, such as at least 18% by weight, such as at least 18% by weight, based on the total weight of the addition polymer. The constitutional units comprising the residue of the alkyl esters of (meth)acrylic acid containing from 4 to 18 carbon atoms in the alkyl group may comprise no more than 60% by weight, such as no more than 50% by weight, such as no more than 45% by weight, such as no more than 40% by weight, such as no more than 35% by weight, based on the total weight of the addition polymer. The constitutional units comprising the residue of the alkyl esters of (meth)acrylic acid containing from 4 to 18 carbon atoms in the alkyl group may comprise 2% to 60% by weight, such as 2% to 50% by weight, such as 2% to 45% by weight, such as 2% to 40% by weight, such as 2% to 35% by weight, such as 5% to 60% by weight, such as 5% to 50% by weight, such as 5% to 45% by weight, such as 5% to 40% by weight, such as 5% to 35% by weight, such as 10% to 60% by weight, such as 10% to 50% by weight, such as 10% to 45% by weight, such as 10% to 40% by weight, such as 10% to 35% by weight, such as 15% to 60% by weight, such as 15% to 50% by weight, such as 15% to 45% by weight, such as 15% to 40% by weight, such as 15% to 35% by weight, such as 18% to 60% by weight, such as 18% to 50% by weight, such as 18% to 45% by weight, such as 18% to 40% by weight, such as 18% to 35% by weight, such as 20% to 60% by weight, such as 20% to 50% by weight, such as 20% to 45% by weight, such as 20% to 40% by weight, such as 20% to 35% by weight, based on the total weight of the addition polymer. The addition polymer may be derived from a reaction mixture comprising the alkyl esters of (meth)acrylic acid containing from 4 to 18 carbon atoms in the alkyl group in an amount of 2% to 60% by weight, such as 2% to 50% by weight, such as 2% to 45% by weight, such as 2% to 40% by weight, such as 2% to 35% by weight, such as 5% to 60% by weight, such as 5% to 50% by weight, such as 5% to 45% by weight, such as 5% to 40% by weight, such as 5% to 35% by weight, such as 10% to 60% by weight, such as 10% to 50% by weight, such as 10% to 45% by weight, such as 10% to 40% by weight, such as 10% to 35% by weight, such as 15% to 60% by weight, such as 15% to 50% by weight, such as 15% to 45% by weight, such as 15% to 40% by weight, such as 15% to 35% by weight, such as 18% to 60% by weight, such as 18% to 50% by weight, such as 18% to 45% by weight, such as 18% to 40% by weight, such as 18% to 35% by weight, such as 20% to 60% by weight, such as 20% to 50% by weight, such as 20% to 45% by weight, such as 20% to 40% by weight, such as 20% to 35% by weight, based on the total weight of polymerizable monomers used in the reaction mixture.

The addition polymer may optionally comprise constitutional units comprising the residue of a hydroxyalkyl ester. Non-limiting examples of hydroxyalkyl esters include hydroxyethyl (meth)acrylate and hydroxypropyl (meth)acrylate. The constitutional units comprising the residue of the hydroxyalkyl ester may comprise at least 0.5% by weight, such as at least 1% by weight, such as at least 1.5% by weight, based on the total weight of the addition polymer. The constitutional units comprising the residue of the hydroxyalkyl ester may comprise no more than 20% by weight, such as no more than 15% by weight, such as no more than 8% by weight, such as no more than 6% by weight, such as no more than 5% by weight, such as no more than 4% by weight, such as no more than 3% by weight, such as no more than 2% by weight, such as no more than 1.5% by weight, such as no more than 1.0% by weight, based on the total weight of the addition polymer. The constitutional units comprising the residue of the hydroxyalkyl ester may comprise 0.5% to 20% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 20% by weight, such as 1% to 15% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 20% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of the addition polymer. The addition polymer may be derived from a reaction mixture comprising the hydroxyalkyl ester in an amount of 0.5% to 20% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 20% by weight, such as 1% to 15% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 20% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of polymerizable monomers used in the reaction mixture. The inclusion of constitutional units comprising the residue of a hydroxyalkyl ester in the addition polymer results in an addition polymer comprising at least one hydroxyl group (although hydroxyl groups may be included by other methods). Hydroxyl groups resulting from inclusion of the hydroxyalkyl esters (or incorporated by other means) may react with a separately added crosslinking agent that comprises functional groups reactive with hydroxyl groups such as, for example, an aminoplast, phenolplast, polyepoxides and blocked polyisocyanates, or with N-alkoxymethyl amide groups or blocked isocyanato groups present in the addition polymer when self-crosslinking monomers that have groups that are reactive with the hydroxyl groups are incorporated into the addition polymer.

The addition polymer may optionally comprise constitutional units comprising the residue of an alpha, beta-ethylenically unsaturated carboxylic acid. Non-limiting examples of alpha, beta-ethylenically unsaturated carboxylic acids include those containing up to 10 carbon atoms such as acrylic acid and methacrylic acid. Non-limiting examples of other unsaturated acids are alpha, beta-ethylenically unsaturated dicarboxylic acids such as maleic acid or its anhydride, fumaric acid and itaconic acid. Also, the half esters of these dicarboxylic acids may be employed. If present, the constitutional units comprising the residue of the alpha, beta-ethylenically unsaturated carboxylic acids may comprise at least 0.5% by weight, such as at least 1% by weight, such as at least 1.5% by weight, based on the total weight of the addition polymer. If present, the constitutional units comprising the residue of the alpha, beta-ethylenically unsaturated carboxylic acids may comprise no more than 10% by weight, such as no more than 8% by weight, such as no more than 6% by weight, such as no more than 5% by weight, such as no more than 4% by weight, such as no more than 3% by weight, such as no more than 2% by weight, such as no more than 1.5% by weight, such as no more than 1.0% by weight, based on the total weight of the addition polymer. The constitutional units comprising the residue of the alpha, beta-ethylenically unsaturated carboxylic acids may comprise 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of the addition polymer. The addition polymer may be derived from a reaction mixture comprising the alpha, beta-ethylenically unsaturated carboxylic acids in an amount of 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of polymerizable monomers used in the reaction mixture. The inclusion of constitutional units comprising the residue of an alpha, beta-ethylenically unsaturated carboxylic acids in the addition polymer results in an addition polymer comprising at least one carboxylic acid group.

The addition polymer optionally may comprise constitutional units comprising the residue of an ethylenically unsaturated monomer comprising a heterocyclic group. Non-limiting examples of ethylenically unsaturated monomers comprising a heterocyclic group include epoxy functional ethylenically unsaturated monomers (e.g., glycidyl (meth)acrylate), vinyl pyrrolidone and vinyl caprolactam, among others. The constitutional units comprising the residue of the ethylenically unsaturated monomers comprising a heterocyclic group may, if present, comprise at least 0.5% by weight, such as at least 1% by weight, such as at least 2% by weight, such as at least 3% by weight, such as at least 4% by weight, such as at least 5% by weight, such as at least 8% by weight, based on the total weight of the addition polymer. The constitutional units comprising the residue of the ethylenically unsaturated monomers comprising a heterocyclic group may, if present, comprise no more than 20% by weight, such as no more than 15% by weight, such as no more than 10% by weight, such as no more than 5% by weight, based on the total weight of the addition polymer. The constitutional units comprising the residue of the ethylenically unsaturated monomers comprising a heterocyclic group may comprise 0% to 20% by weight, such as 0.5% to 20% by weight, such as 0.5% to 15% by weight, such as 0.5% to 10% by weight, such as 0.5% to 5% by weight, such as 1% to 20% by weight, such as 1% to 15% by weight, such as 1% to 10% by weight, such as 1% to 5% by weight, such as 2% to 20% by weight, such as 2% to 15% by weight, such as 2% to 10% by weight, such as 2% to 5% by weight, such as 3% to 20% by weight, such as 3% to 15% by weight, such as 3% to 10% by weight, such as 3% to 5% by weight, such as 4% to 20% by weight, such as 4% to 15% by weight, such as 4% to 10% by weight, such as 4% to 5% by weight, such as 5% to 20% by weight, such as 5% to 15% by weight, such as 5% to 10% by weight, such as 8% to 20% by weight, such as 8% to 15% by weight, such as 8% to 10% by weight, based on the total weight of the addition polymer. The addition polymer may be derived from a reaction mixture comprising the ethylenically unsaturated monomers comprising a heterocyclic group in an amount of such as 0.5% to 20% by weight, such as 0.5% to 15% by weight, such as 0.5% to 10% by weight, such as 0.5% to 5% by weight, such as 1% to 20% by weight, such as 1% to 15% by weight, such as 1% to 10% by weight, such as 1% to 5% by weight, such as 2% to 20% by weight, such as 2% to 15% by weight, such as 2% to 10% by weight, such as 2% to 5% by weight, such as 3% to 20% by weight, such as 3% to 15% by weight, such as 3% to 10% by weight, such as 3% to 5% by weight, such as 4% to 20% by weight, such as 4% to 15% by weight, such as 4% to 10% by weight, such as 4% to 5% by weight, such as 5% to 20% by weight, such as 5% to 15% by weight, such as 5% to 10% by weight, such as 8% to 20% by weight, such as 8% to 15% by weight, such as 8% to 10% by weight, based on the total weight of polymerizable monomers used in the reaction mixture.

As noted above, the addition polymer may optionally comprise constitutional units comprising the residue of a self-crosslinking monomer, and the addition polymer may comprise a self-crosslinking addition polymer. As used herein, the term “self-crosslinking monomer” refers to monomers that incorporate functional groups that may react with active hydrogen functional groups present on the addition polymer to form a crosslink between the addition polymer or more than one addition polymer, and the term “self-crosslinking monomer” expressly excludes monomers having silicon-containing groups. Non-limiting examples of self-crosslinking monomers include N-alkoxymethyl (meth)acrylamide monomers such as N-butoxymethyl (meth)acrylamide and N-isopropoxymethyl (meth)acrylamide. The constitutional units comprising the residue of the self-crosslinking monomer may comprise at least 0.5% by weight, such as at least 1% by weight, such as at least 1.5% by weight, based on the total weight of the addition polymer. The constitutional units comprising the residue of the self-crosslinking monomer may comprise no more than 20% by weight, such as no more than 15% by weight, such as no more than 8% by weight, such as no more than 6% by weight, such as no more than 5% by weight, such as no more than 4% by weight, such as no more than 3% by weight, such as no more than 2% by weight, such as no more than 1.5% by weight, such as no more than 1.0% by weight, based on the total weight of the addition polymer. The constitutional units comprising the residue of the self-crosslinking monomer may comprise 0.5% to 20% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 20% by weight, such as 1% to 15% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 20% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of the addition polymer. The addition polymer may be derived from a reaction mixture comprising the self-crosslinking monomer in an amount of 0.5% to 20% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 20% by weight, such as 1% to 15% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 20% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of polymerizable monomers used in the reaction mixture.

The addition polymer may optionally comprise constitutional units comprising the residue of a vinyl aromatic compound. Non-limiting examples of vinyl aromatic compounds includes styrene, alpha-methyl styrene, alpha-chlorostyrene and vinyl toluene. The constitutional units comprising the residue of the vinyl aromatic compound may comprise at least 1% by weight, such as at least 5% by weight, such as at least 10% by weight, such as at least 15% by weight, such as at least 20% by weight, such as at least 25% by weight, based on the total weight of the addition polymer. The constitutional units comprising the residue of the vinyl aromatic compound may comprise no more than 80% by weight, such as no more than 65% by weight, such as no more than 50% by weight, such as no more than 40% by weight, such as no more than 30% by weight, such as no more than 20% by weight, such as no more than 15% by weight, such as no more than 10% by weight, such as no more than 5% by weight, such as no more than 2.5% by weight, based on the total weight of the addition polymer. The constitutional units comprising the residue of the vinyl aromatic compound may comprise 1% to 80% by weight, such as 1% to 65% by weight, such as 1% to 50% by weight, such as 1% to 40% by weight, such as 1% to 30% by weight, such as 1% to 20% by weight, such as 1% to 15% by weight, such as 1% to 10% by weight, such as 1% to 5% by weight, such as 1% to 2.5% by weight, such as 5% to 80% by weight, such as 5% to 65% by weight, such as 5% to 50% by weight, such as 5% to 40% by weight, such as 5% to 30% by weight, such as 5% to 20% by weight, such as 5% to 15% by weight, such as 5% to 10% by weight, such as 10% to 80% by weight, such as 10% to 65% by weight, such as 10% to 50% by weight, such as 10% to 40% by weight, such as 10% to 30% by weight, such as 10% to 20% by weight, such as 10% to 15% by weight, such as 15% to 80% by weight, such as 15% to 65% by weight, such as 15% to 50% by weight, such as 15% to 40% by weight, such as 15% to 30% by weight, such as 15% to 20% by weight, such as 20% to 80% by weight, such as 20% to 65% by weight, such as 20% to 50% by weight, such as 20% to 40% by weight, such as 20% to 30% by weight, such as 25% to 80% by weight, such as 25% to 65% by weight, such as 25% to 50% by weight, such as 25% to 40% by weight, such as 25% to 30% by weight, based on the total weight of the addition polymer. The addition polymer may be derived from a reaction mixture comprising the vinyl aromatic compound in an amount of such as 1% to 80% by weight, such as 1% to 65% by weight, such as 1% to 50% by weight, such as 1% to 40% by weight, such as 1% to 30% by weight, such as 1% to 20% by weight, such as 1% to 15% by weight, such as 1% to 10% by weight, such as 1% to 5% by weight, such as 1% to 2.5% by weight, such as 5% to 80% by weight, such as 5% to 65% by weight, such as 5% to 50% by weight, such as 5% to 40% by weight, such as 5% to 30% by weight, such as 5% to 20% by weight, such as 5% to 15% by weight, such as 5% to 10% by weight, such as 10% to 80% by weight, such as 10% to 65% by weight, such as 10% to 50% by weight, such as 10% to 40% by weight, such as 10% to 30% by weight, such as 10% to 20% by weight, such as 10% to 15% by weight, such as 15% to 80% by weight, such as 15% to 65% by weight, such as 15% to 50% by weight, such as 15% to 40% by weight, such as 15% to 30% by weight, such as 15% to 20% by weight, such as 20% to 80% by weight, such as 20% to 65% by weight, such as 20% to 50% by weight, such as 20% to 40% by weight, such as 20% to 30% by weight, such as 25% to 80% by weight, such as 25% to 65% by weight, such as 25% to 50% by weight, such as 25% to 40% by weight, such as 25% to 30% by weight, based on the total weight of polymerizable monomers used in the reaction mixture.

The addition polymer may optionally comprise constitutional units comprising the residue of a vinyl ester monomer. As used herein, a “vinyl ester” monomer refers to a compound having the structure C═C—O—C(O)—R, wherein R is an alkyl group having 1 to 5 carbon atoms. Non-limiting examples of vinyl ester monomers include vinyl acetate, vinyl propionate, and the like. The constitutional units comprising the residue of the vinyl ester monomer may comprise at least 1% by weight, such as at least 5% by weight, such as at least 10% by weight, such as at least 15% by weight, such as at least 20% by weight, such as at least 25% by weight, based on the total weight of the addition polymer. The constitutional units comprising the residue of the vinyl ester monomer may comprise no more than 80% by weight, such as no more than 65% by weight, such as no more than 50% by weight, such as no more than 40% by weight, such as no more than 30% by weight, such as no more than 20% by weight, such as no more than 15% by weight, such as no more than 10% by weight, based on the total weight of the addition polymer. The constitutional units comprising the residue of the vinyl ester monomer may comprise 1% to 80% by weight, such as 1% to 65% by weight, such as 1% to 50% by weight, such as 1% to 40% by weight, such as 1% to 30% by weight, such as 1% to 20% by weight, such as 1% to 15% by weight, such as 1% to 10% by weight, such as 5% to 80% by weight, such as 5% to 65% by weight, such as 5% to 50% by weight, such as 5% to 40% by weight, such as 5% to 30% by weight, such as 5% to 20% by weight, such as 5% to 15% by weight, such as 5% to 10% by weight, such as 10% to 80% by weight, such as 10% to 65% by weight, such as 10% to 50% by weight, such as 10% to 40% by weight, such as 10% to 30% by weight, such as 10% to 20% by weight, such as 10% to 15% by weight, such as 15% to 80% by weight, such as 15% to 65% by weight, such as 15% to 50% by weight, such as 15% to 40% by weight, such as 15% to 30% by weight, such as 15% to 20% by weight, such as 20% to 80% by weight, such as 20% to 65% by weight, such as 20% to 50% by weight, such as 20% to 40% by weight, such as 20% to 30% by weight, such as 25% to 80% by weight, such as 25% to 65% by weight, such as 25% to 50% by weight, such as 25% to 40% by weight, such as 25% to 30% by weight, based on the total weight of the addition polymer. The addition polymer may be derived from a reaction mixture comprising the vinyl ester monomer in an amount of such as 1% to 80% by weight, such as 1% to 65% by weight, such as 1% to 50% by weight, such as 1% to 40% by weight, such as 1% to 30% by weight, such as 1% to 20% by weight, such as 1% to 15% by weight, such as 1% to 10% by weight, such as 5% to 80% by weight, such as 5% to 65% by weight, such as 5% to 50% by weight, such as 5% to 40% by weight, such as 5% to 30% by weight, such as 5% to 20% by weight, such as 5% to 15% by weight, such as 5% to 10% by weight, such as 10% to 80% by weight, such as 10% to 65% by weight, such as 10% to 50% by weight, such as 10% to 40% by weight, such as 10% to 30% by weight, such as 10% to 20% by weight, such as 10% to 15% by weight, such as 15% to 80% by weight, such as 15% to 65% by weight, such as 15% to 50% by weight, such as 15% to 40% by weight, such as 15% to 30% by weight, such as 15% to 20% by weight, such as 20% to 80% by weight, such as 20% to 65% by weight, such as 20% to 50% by weight, such as 20% to 40% by weight, such as 20% to 30% by weight, such as 25% to 80% by weight, such as 25% to 65% by weight, such as 25% to 50% by weight, such as 25% to 40% by weight, such as 25% to 30% by weight, based on the total weight of polymerizable monomers used in the reaction mixture.

The addition polymer may optionally comprise constitutional units comprising the residue of other alpha, beta-ethylenically unsaturated monomers. Non-limiting examples of other alpha, beta-ethylenically unsaturated monomers include organic nitriles such as acrylonitrile and methacrylonitrile; allyl monomers such as allyl chloride and allyl cyanide; monomeric dienes such as 1,3-butadiene and 2-methyl-1,3-butadiene; and acetoacetoxyalkyl (meth)acrylates such as acetoacetoxyethyl methacrylate (AAEM) (which may be self-crosslinking). The constitutional units comprising the residue of the other alpha, beta-ethylenically unsaturated monomers may comprise at least at least 0.5% by weight, such as at least 1% by weight, such as at least 1.5% by weight, based on the total weight of the addition polymer. The constitutional units comprising the residue of the other alpha, beta-ethylenically unsaturated monomers may comprise no more than 20% by weight, such as no more than 15% by weight, such as no more than 8% by weight, such as no more than 6% by weight, such as no more than 5% by weight, such as no more than 4% by weight, such as no more than 3% by weight, such as no more than 2% by weight, such as no more than 1.5% by weight, such as no more than 1.0% by weight, based on the total weight of the addition polymer. The constitutional units comprising the residue of the other alpha, beta-ethylenically unsaturated monomers may comprise 0.5% to 20% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 20% by weight, such as 1% to 15% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 20% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of the addition polymer. The addition polymer may be derived from a reaction mixture comprising the other alpha, beta-ethylenically unsaturated monomers in an amount of 0.5% to 20% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 20% by weight, such as 1% to 15% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 20% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of polymerizable monomers used in the reaction mixture.

The addition polymer may comprise functional groups. The functional groups may comprise, for example, active hydrogen functional groups, heterocyclic groups, silicon-containing functional groups, and any combination thereof, and the functional groups may be incorporated through the use of the monomers discussed above as well as any other functionalized ethylenically unsaturated monomer or post-reacted compound. As used herein, the term “active hydrogen functional groups” refers to those groups that are reactive with isocyanates as determined by the Zerewitinoff test described in the JOURNAL OF THE AMERICAN CHEMICAL SOCIETY, Vol. 49, page 3181 (1927), and include, for example, hydroxyl groups, primary or secondary amino groups, carboxylic acid groups, and thiol groups. As used herein, the term “heterocyclic group” refers to a cyclic group containing at least two different elements in its ring such as a cyclic moiety having at least one atom in addition to carbon in the ring structure, such as, for example, oxygen, nitrogen or sulfur. Non-limiting examples of heterocylic groups include epoxides, aziridines, thioepoxides, lactams and lactones. In addition, when epoxide functional groups are present on the addition polymer, the epoxide functional groups on the addition polymer optionally may be post-reacted with an acid, such as a beta-hydroxy functional acid. Non-limiting examples of beta-hydroxy functional acids include citric acid, tartaric acid, and/or an aromatic acid, such as 3-hydroxy-2-naphthoic acid. The ring opening reaction of the epoxide functional group will yield hydroxyl functional groups on the addition polymer.

The monomers and relative amounts may be selected such that the resulting addition polymer has a Tg of 100° C. or less. The resulting addition polymer may have a Tg of, for example, at least −50° C., such as at least −40° C., such as −30° C., such as, −20° C., such as −15° C., such as −10° C., such as −5° C., such as 0° C. The resulting addition polymer may have a Tg of, for example, no more than +70° C., such as no more than +60° C., such as no more than +50° C., such as no more than +40° C., such as no more than +25° C., such as no more than +15° C., such as no more than +10° C., such as no more than +5° C., such as no more than 0° C. The resulting addition polymer may have a Tg of, for example, −50 to +70° C., such as −50 to +60° C., such as −50 to +50° C., such as −50 to +40° C., such as −50 to +25° C., such as −50 to +20° C., such as −50 to +15° C., such as −50 to +10° C., such as −50 to +5° C., such as −50 to 0° C., such as −40 to +50° C., such as −40 to +40° C., such as −40 to +25° C., such as −40 to +20° C., such as −40 to +15° C., such as −40 to +10° C., such as −40 to +5° C., such as −40 to 0° C., such as −30 to +50° C., such as −30 to +40° C., such as −30 to +25° C., such as −30 to +20° C., such as −30 to +15° C., such as −30 to +10° C., such as −30 to +5° C., such as −30 to 0° C., such as −20 to +50° C., such as −20 to +40° C., such as −20 to +25° C., such as −20 to +20° C., such as −20 to +15° C., such as −20 to +10° C., such as −20 to +5° C. such as −20 to 0° C., such as −15 to +50° C., such as −15 to +40° C., such as −15 to +25° C., such as −15 to +20° C., such as −15 to +15° C., such as −15 to +10° C., such as −15 to +5° C., such as −15 to 0° C., such as −10 to +50° C., such as −10 to +40° C., such as −10 to +25° C., such as −10 to +20° C., such as −10 to +15° C., such as −10 to +10° C., such as −10 to +5° C., such as −10 to 0° C., such as −5 to +50° C., such as −5 to +40° C., such as −5 to +25° C., such as −5 to +20° C., such as −5 to +15° C. such as −5 to +10° C., such as −5 to +5° C., such as −5 to 0° C., such as 0 to +50° C., such as 0 to +40° C., such as 0 to +25° C., such as 0 to +20° C., such as 0 to +15° C. A Tg that is below 0° C. may be desirable to ensure acceptable battery performance at low temperature (e.g., 0° C. or less).

The addition polymer may have a number average molecular weight of at least 1,000 g/mol, such as at least 1,500 g/mol, such as at least 2,500 g/mol, such as at least 5,000 g/mol, such as at least 7,500 g/mol, such at least 10,000 g/mol. The addition polymer may have a number average molecular weight of no more than 100,000 g/mol, such as no more than 75,000 g/mol, such as no more than 50,000 g/mol, such as no more than 25,000 g/mol, such as no more than 20,000 g/mol, such as no more than 15,000 g/mol, such as no more than 10,000 g/mol, such as no more than 7,500 g/mol. The addition polymer may have a number average molecular weight of 1,000 to 100,000 g/mol, such as 1,000 to 75,000 g/mol, such as 1,000 to 50,000 g/mol, such as 1,000 to 25,000 g/mol, such as 1,000 to 20,000 g/mol, such as 1,000 to 15,000 g/mol, such as 1,000 to 12,500 g/mol, such as 1,000 to 10,000 g/mol, such as 1,000 to 7,500 g/mol, such as 1,500 to 100,000 g/mol, such as 1,500 to 75,000 g/mol, such as 1,500 to 50,000 g/mol, such as 1,500 to 25,000 g/mol, such as 1,500 to 20,000 g/mol, such as 1,500 to 15,000 g/mol, such as 1,500 to 12,500 g/mol, such as 1,500 to 10,000 g/mol, such as 1,500 to 7,500 g/mol, such as 2,500 to 100,000 g/mol, such as 2,500 to 75,000 g/mol, such as 2,500 to 50,000 g/mol, such as 2,500 to 25,000 g/mol, such as 2,500 to 20,000 g/mol, such as 2,500 to 15,000 g/mol, such as 2,500 to 12,500 g/mol, such as 2,500 to 10,000 g/mol, such as 2,500 to 7,500 g/mol, 5,000 to 100,000 g/mol, such as 5,000 to 75,000 g/mol, such as 5,000 to 50,000 g/mol, such as 5,000 to 25,000 g/mol, such as 5,000 to 20,000 g/mol, such as 5,000 to 15,000 g/mol, such as 5,000 to 12,500 g/mol, such as 5,000 to 10,000 g/mol, such as 5,000 to 7,500 g/mol, 7,500 to 100,000 g/mol, such as 7,500 to 75,000 g/mol, such as 7,500 to 50,000 g/mol, such as 7,500 to 25,000 g/mol, such as 7,500 to 20,000 g/mol, such as 7,500 to 15,000 g/mol, such as 7,500 to 12,500 g/mol, such as 7,500 to 10,000 g/mol, 10,000 to 100,000 g/mol, such as 10,000 to 75,000 g/mol, such as 10,000 to 50,000 g/mol, such as 10,000 to 25,000 g/mol, such as 10,000 to 20,000 g/mol, such as 10,000 to 15,000 g/mol, such as 10,000 to 12,500 g/mol.

The addition polymer may have a weight average molecular weight of at least at least 2,000 g/mol, such as at least 5,000 g/mol, such as at least 10,000 g/mol, such as at least 15,000 g/mol, such at least 20,000 g/mol. The addition polymer may have a weight average molecular weight of no more than 1,000,000 g/mol, such as no more than 500,000 g/mol, such as no more than 200,000 g/mol, such as no more than 150,000 g/mol, such as no more than 100,000 g/mol, such as no more than 50,000 g/mol, such as no more than 40,000 g/mol, such as no more than 30,000 g/mol, such as no more than 20,000 g/mol, such as no more than 15,000 g/mol. The addition polymer may have a weight average molecular weight of 2,000 to 1,000,000 g/mol, such as 2,000 to 500,000 g/mol, such as 2,000 to 200,000 g/mol, such as 2,000 to 150,000 g/mol, such as 2,000 to 100,000 g/mol, such as 2,000 to 50,000 g/mol, such as 2,000 to 40,000 g/mol, such as 2,000 to 30,000 g/mol, such as 2,000 to 25,000 g/mol, such as 2,000 to 20,000 g/mol, such as 2,000 to 15,000 g/mol, such as 5,000 to 1,000,000 g/mol, such as 5,000 to 500,000 g/mol, such as 5,000 to 200,000 g/mol, such as 5,000 to 150,000 g/mol, such as 5,000 to 100,000 g/mol, such as 5,000 to 50,000 g/mol, such as 5,000 to 40,000 g/mol, such as 5,000 to 30,000 g/mol, such as 5,000 to 25,000 g/mol, such as 5,000 to 20,000 g/mol, such as 5,000 to 15,000 g/mol, such as 10,000 to 1,000,000 g/mol, such as 10,000 to 500,000 g/mol, such as 10,000 to 200,000 g/mol, such as 10,000 to 150,000 g/mol, such as 10,000 to 100,000 g/mol, such as 10,000 to 50,000 g/mol, such as 10,000 to 40,000 g/mol, such as 10,000 to 30,000 g/mol, such as 10,000 to 25,000 g/mol, such as 10,000 to 20,000 g/mol, such as 10,000 to 15,000 g/mol, such as 15,000 to 1,000,000 g/mol, such as 15,000 to 500,000 g/mol, such as 15,000 to 200,000 g/mol, such as 15,000 to 150,000 g/mol, such as 15,000 to 100,000 g/mol, such as 15,000 to 50,000 g/mol, such as 15,000 to 40,000 g/mol, such as 15,000 to 30,000 g/mol, such as 15,000 to 25,000 g/mol, such as 15,000 to 20,000 g/mol, such as 20,000 to 200,000 g/mol, such as 20,000 to 150,000 g/mol, such as 20,000 to 100,000 g/mol, such as 20,000 to 50,000 g/mol, such as 20,000 to 40,000 g/mol, such as 20,000 to 30,000 g/mol, such as 20,000 to 25,000 g/mol.

The addition polymer may be prepared by conventional free radical initiated solution polymerization techniques in which the polymerizable monomers are dissolved in an organic medium comprising a solvent or a mixture of solvents and polymerized in the presence of a free radical initiator until conversion is complete.

Examples of free radical initiators are those which are soluble in the mixture of monomers or organic medium such as azobisisobutyronitrile, azobis (alpha, gamma-methylvaleronitrile), tertiary-butyl perbenzoate, tertiary-butyl peracetate, benzoyl peroxide, ditertiary-butyl peroxide, ditertiary-amyl peroxide, and tertiary amyl peroxy 2-ethylhexyl carbonate.

Optionally, a chain transfer agent which is soluble in the mixture of monomers such as alkyl mercaptans, for example, tertiary-dodecyl mercaptan; ketones such as methyl ethyl ketone, chlorohydrocarbons such as chloroform can be used. A chain transfer agent provides control over the molecular weight to give products having required viscosity for various coating applications. Tertiary-dodecyl mercaptan is preferred because it results in high conversion of monomer to polymeric product.

To prepare the addition polymer, the solvent may be first heated to reflux and the mixture of polymerizable monomers and the free radical initiator may be separately added slowly to the refluxing solvent. The reaction mixture is then held at polymerizing temperatures so as to reduce the free monomer content, such as to below 1.0 percent and usually below 0.5 percent, based on the total weight of the mixture of polymerizable monomers.

The addition polymer may be present in the binder in amounts of at least 0.1% by weight, such as at least 1% by weight, such as at least 2% by weight, such as at least 3% by weight, such as at least 4% by weight, such as at least 5% by weight, based on the total weight of the binder solids. The addition polymer may be present in the binder in amounts of no more than 25% by weight, such as no more than 20% by weight, such as no more than 15% by weight, such as no more than 12.5% by weight, such as no more than 10% by weight, such as no more than 5% by weight, based on the total weight of the binder solids. The addition polymer may be present in the binder in amounts of 0.1% to 25% by weight, such as 0.1% to 20% by weight, such as 0.1% to 15% by weight, such as 0.1% to 12.5% by weight, such as 0.1% to 10% by weight, such as 0.1% to 5% by weight, such as 1% to 25% by weight, such as 1% to 20% by weight, such as 1% to 15% by weight, such as 1% to 12.5% by weight, such as 1% to 10% by weight, such as 1% to 5% by weight, such as 2% to 25% by weight, such as 2% to 20% by weight, such as 2% to 15% by weight, such as 2% to 12.5% by weight, such as 2% to 10% by weight, such as 2% to 5% by weight, such as 3% to 25% by weight, such as 3% to 20% by weight, such as 3% to 15% by weight, such as 3% to 12.5% by weight, such as 3% to 10% by weight, such as 3% to 5% by weight, such as 4% to 25% by weight, such as 4% to 20% by weight, such as 4% to 15% by weight, such as 4% to 12.5% by weight, such as 4% to 10% by weight, such as 4% to 5% by weight, such as 5% to 25% by weight, such as 5% to 20% by weight, such as 5% to 15% by weight, such as 5% to 12.5% by weight, such as 5% to 10% by weight, based on the total weight of the binder solids.

The addition polymer may be present in the slurry composition in an amount of at least 0.1% by weight, such as at least 1% by weight, such as at least 1.3% by weight, such as at least 1.5% by weight, such as at least 1.9% by weight, based on the total solids weight of the slurry composition. The addition polymer may be present in the slurry composition in an amount of no more than 10% by weight, such as no more than 6% by weight, such as no more than 4.5% by weight, such as no more than 2.9% by weight, such as no more than 2.5% by weight, such as no more than 2% by weight, based on the total solids weight of the slurry composition. The addition polymer may be present in the slurry composition in an amount of 0.1% to 10% by weight, such as 0.1% to 6% by weight, such as 0.1% to 4.5% by weight, such as 0.1% to 2.9% by weight, such as 0.1% to 2.5% by weight, such as 0.1% to 2% by weight, such as 1% to 10% by weight, such as 1% to 6% by weight, such as 1% to 4.5% by weight, such as 1% to 2.9% by weight, such as 1% to 2.5% by weight, such as 1% to 2% by weight, such as 1.3% to 10% by weight, such as 1.3% to 6% by weight, such as 1.3% to 4.5% by weight, such as 1.3% to 2.9% by weight, such as 1.3% to 2.5% by weight, such as 1.3% to 2% by weight, such as 1.5% to 10% by weight, such as 1.5% to 6% by weight, such as 1.5% to 4.5% by weight, such as 1.5% to 2.9% by weight, such as 1.5% to 2.5% by weight, such as 1.5% to 2% by weight, such as 1.9% to 10% by weight, such as 1.9% to 6% by weight, such as 1.9% to 4.5% by weight, such as 1.9% to 2.9% by weight, such as 1.9% to 2.5% by weight, such as 1.9% to 2% by weight, such as 1% to 10% by weight, such as 1% to 6% by weight, such as 1% to 4.5% by weight, such as 1% to 2.9% by weight, such as 1% to 2.5% by weight, such as 1% to 2% by weight, based on the total solids weight of the slurry composition.

The solvent system of the slurry composition may comprise, consist essentially of, or consist of the trialkyl phosphate and the co-solvent, and slurry composition may have a viscosity of at least 5,000 cP at 10 s⁻¹, such as at least 10,000 cP at 10 s⁻¹, as measured by Anton Paar MCR 302 rheometer with a 50 mm diameter cone-plate at 25° C. The solvent system of the slurry composition may comprise, consist essentially of, or consist of the trialkyl phosphate and the co-solvent, and slurry composition may have a viscosity of no more than 15,000 cP at 10 s⁻¹, such as no more than 10,000 cP at 10 s⁻¹, as measured by Anton Paar MCR 302 rheometer with a 50 mm diameter cone-plate at 25° C. The solvent system of the slurry composition may comprise, consist essentially of, or consist of the trialkyl phosphate and the co-solvent, and slurry composition may have a viscosity of 5,000 to 15,000 cP at 10 s⁻¹, such as 10,000 to 15,000 cP at 10 s⁻¹, such as 5,000 to 10,000 cP at 10 s⁻¹, as measured by Anton Paar MCR 302 rheometer with a 50 mm diameter cone-plate at 25° C.

The solvent system of the slurry composition may comprise, consist essentially of, or consist of the trialkyl phosphate and the co-solvent, and slurry composition may have a room temperature stability of ≥1 week, such as ≥1 month. As used herein, “room temperature stability” means that a slurry composition stored in a container will maintain a clear appearance to visual inspection without gelling for a specified period of time.

The solvent system of the slurry composition may comprise, consist essentially of, or consist of the trialkyl phosphate and the co-solvent, and a film deposited from the slurry composition has a peel strength of at least 5 N/m, such as at least 8 N/m, such as at least 10 N/m, such as at least 15 N/m, such as at least 20 N/m, such as at least 25 N/m, as measured by the PEEL STRENGTH TEST.

The solvent system of the slurry composition may comprise, consist essentially of, or consist of the trialkyl phosphate and the lactone, and slurry composition may have a viscosity of at least 1,000 cP at 10 s⁻¹, such as at least 2,000 cP at 10 s⁻¹, such as at least 4,000 cP at 10 s⁻¹, such as at least 10,000 cP at 10 s⁻¹, such as at least 15,000 cP at 10 s⁻¹, such as at least 20,000 cP at 10 s⁻¹, as measured by an Anton Paar MCR 302 rheometer with a 50 mm diameter cone-plate at 25° C. The solvent system of the slurry composition may comprise, consist essentially of, or consist of the trialkyl phosphate and the lactone, and slurry composition may have a viscosity of no more than 30,000 cP at 10 s⁻¹, no more than 25,000 cP at 10 s⁻¹, such as no more than 20,000 cP at 10 s⁻¹, such as no more than 15,000 cP at 10 s⁻¹, such as no more than 10,000 cP at 10 s⁻¹, such as no more than 8,000 cP at 10 s⁻¹, as measured by Anton Paar MCR 302 rheometer with a 50 mm diameter cone-plate at 25° C. The solvent system of the slurry composition may comprise, consist essentially of, or consist of the trialkyl phosphate and the lactone, and slurry composition may have a viscosity of 1,000 to 30,000 cP at 10 s⁻¹, 2,000 to 30,000 cP at 10 s⁻¹, such as such as 4,000 to 30,000 cP at 10 s⁻¹, such as 10,000 to 30,000 cP at 10 s⁻¹, such as 15,000 to 30,000 cP at 10 s⁻¹, such as 20,000 to 30,000 cP at 10 s⁻¹, such as 1,000 to 25,000 cP at 10 s⁻¹, 2,000 to 25,000 cP at 10 s⁻¹, such as such as 4,000 to 25,000 cP at 10 s⁻¹, such as 10,000 to 25,000 cP at 10 s⁻¹, such as 15,000 to 25,000 cP at 10 s⁻¹, such as 20,000 to 25,000 cP at 10 s⁻¹, such as 1,000 to 20,000 cP at 10 s⁻¹, such as 1,000 to 20,000 cP at 10 s⁻¹, such as 4,000 to 20,000 cP at 10 s⁻¹, such as 10,000 to 20,000 cP at 10 s⁻¹, such as 15,000 to 20,000 cP at 10 s⁻¹, such as 1,000 to 15,000 cP at 10 s⁻¹, such as 2,000 to 15,000 cP at 10 s⁻¹, such as 4,000 to 15,000 cP at 10 s⁻¹, such as 10,000 to 15,000 cP at 10 s⁻¹, such as 1,000 to 10,000 cP at 10 s⁻¹, such as 2,000 to 10,000 cP at 10 s⁻¹, such as 4,000 to 10,000 cP at 10 s⁻¹, such as 1,000 to 8,000 cP at 10 s⁻¹, such as 2,000 to 8,000 cP at 10 s⁻¹, such as 4,000 to 8,000 cP at 10 s⁻¹, as measured by Anton Paar MCR 302 rheometer with a 50 mm diameter cone-plate at 25° C.

The solvent system of the slurry composition may comprise, consist essentially of, or consist of the trialkyl phosphate and the lactone, and slurry composition may have a room temperature stability of ≥1 week.

The solvent system of the slurry composition may comprise, consist essentially of, or consist of the trialkyl phosphate and the lactone, and a film deposited from the slurry composition has a peel strength of at least 5 N/m, such as at least 8 N/m, such as at least 10 N/m, such as at least 15 N/m, as measured by the PEEL STRENGTH TEST.

The solvent system of the slurry composition may comprise, consist essentially of, or consist of the trialkyl phosphate and the molecule comprising a sulfoxide and/or sulfone functional group, and slurry composition may have a viscosity of at least 1,000 cP at 10 s⁻¹, such as at least 2,000 cP at 10 s⁻¹, such as at least 4,000 cP at 10 s⁻¹, such as at least 10,000 cP at 10 s⁻¹, such as at least 15,000 cP at 10 s⁻¹, such as at least 20,000 cP at 10 s⁻¹, as measured by Anton Paar MCR 302 rheometer with a 50 mm diameter cone-plate at 25° C. The solvent system of the slurry composition may comprise, consist essentially of, or consist of the trialkyl phosphate and the molecule comprising a sulfoxide and/or sulfone functional group, and slurry composition may have a viscosity of no more than 30,000 cP at 10 s⁻¹, no more than 25,000 cP at 10 s⁻¹, such as no more than 20,000 cP at 10 s⁻¹, such as no more than 15,000 cP at 10 s⁻¹, such as no more than 10,000 cP at 10 s⁻¹, such as no more than 8,000 cP at 10 s⁻¹, as measured by Anton Paar MCR 302 rheometer with a 50 mm diameter cone-plate at 25° C. The solvent system of the slurry composition may comprise, consist essentially of, or consist of the trialkyl phosphate and the molecule comprising a sulfoxide and/or sulfone functional group, and slurry composition may have a viscosity of 1,000 to 30,000 cP at 10 s⁻¹, 2,000 to 30,000 cP at 10 s⁻¹, such as such as 4,000 to 30,000 cP at 10 s⁻¹, such as 10,000 to 30,000 cP at 10 s⁻¹, such as 15,000 to 30,000 cP at 10 s⁻¹, such as 20,000 to 30,000 cP at 10 s⁻¹, such as 1,000 to 25,000 cP at 10 s⁻¹, 2,000 to 25,000 cP at 10 s⁻¹, such as such as 4,000 to 25,000 cP at 10 s⁻¹, such as 10,000 to 25,000 cP at 10 s⁻¹, such as 15,000 to 25,000 cP at 10 s⁻¹, such as 20,000 to 25,000 cP at 10 s⁻¹, such as 1,000 to 20,000 cP at 10 s⁻¹, such as 1,000 to 20,000 cP at 10 s⁻¹, such as 4,000 to 20,000 cP at 10 s⁻¹, such as 10,000 to 20,000 cP at 10 s⁻¹, such as 15,000 to 20,000 cP at 10 s⁻¹, such as 1,000 to 15,000 cP at 10 s⁻¹, such as 2,000 to 15,000 cP at 10 s⁻¹, such as 4,000 to 15,000 cP at 10 s⁻¹, such as 10,000 to 15,000 cP at 10 s⁻¹, such as 1,000 to 10,000 cP at 10 s⁻¹, such as 2,000 to 10,000 cP at 10 s⁻¹, such as 4,000 to 10,000 cP at 10 s⁻¹, such as 1,000 to 8,000 cP at 10 s⁻¹, such as 2,000 to 8,000 cP at 10 s⁻¹, such as 4,000 to 8,000 cP at 10 s⁻¹, as measured by Anton Paar MCR 302 rheometer with a 50 mm diameter cone-plate at 25° C.

The solvent system of the slurry composition may comprise, consist essentially of, or consist of the trialkyl phosphate and the molecule comprising a sulfoxide and/or sulfone functional group, and slurry composition may have a room temperature stability of ≥1 month.

The solvent system of the slurry composition may comprise, consist essentially of, or consist of the trialkyl phosphate and the molecule comprising a sulfoxide and/or sulfone functional group, and a film deposited from the slurry composition has a peel strength of at least 5 N/m, such as at least 8 N/m, such as at least 10 N/m, such as at least 15 N/m, such as at least 20 N/m, such as at least 25 N/m, as measured by the PEEL STRENGTH TEST.

The binder composition and/or slurry composition may be substantially free, essentially free, or completely free of N-Methyl-2-pyrrolidone (NMP). As used herein, the binder composition and/or slurry composition is “substantially free” of NMP if NMP is present, if at all, in an amount of less than 5% by weight, based on the total weight of the binder composition and/or slurry composition. As used herein, the binder composition and/or slurry composition is “essentially free” of NMP if NMP is present, if at all, in an amount of less than 0.3% by weight, based on the total weight of the binder composition and/or slurry composition. As used herein, the binder composition and/or slurry composition is “completely free” of NMP if NMP is not present in the binder composition and/or slurry composition, i.e., 0.000% by weight, based on the total weight of the binder composition and/or slurry composition.

The binder composition and/or slurry composition may be substantially free, essentially free, or completely free of ketones such as methyl ethyl ketone, cyclohexanone, isophorone, acetophenone.

The binder composition and/or slurry composition may be substantially free, essentially free, or completely free of ethers such as the C₁ to C₄ alkyl ethers of ethylene or propylene glycol.

The fluoropolymer and/or slurry composition may be substantially free, essentially free, or completely free of fluoroethylene, such as tetrafluoroethylene.

The fluoropolymer and/or slurry composition may be substantially free, essentially free, or completely free of fluorosurfactant.

The binder composition and/or slurry composition may be substantially free, essentially free, or completely free of siloxane.

As noted above, the binder composition and/or slurry composition may optionally further comprise a separately added crosslinking agent for reaction with other components of the binder. The crosslinking agent should be soluble or dispersible in the solvent system and be reactive with active hydrogen groups of the other components of the binder, such as the carboxylic acid groups and the hydroxyl groups, if present. Non-limiting examples of suitable crosslinking agents include aminoplast resins, blocked polyisocyanates and polyepoxides.

Examples of aminoplast resins for use as a crosslinking agent are those which are formed by reacting a triazine such as melamine or benzoguanamine with formaldehyde. These reaction products contain reactive N-methylol groups. Usually, these reactive groups are etherified with methanol, ethanol, butanol including mixtures thereof to moderate their reactivity. For the chemistry preparation and use of aminoplast resins, see “The Chemistry and Applications of Amino Crosslinking Agents or Aminoplast”, Vol. V, Part II, page 21 ff., edited by Dr. Oldring; John Wiley & Sons/Cita Technology Limited, London, 1998. These resins are commercially available under the trademark MAPRENAL® such as MAPRENAL MF980 and under the trademark CYMEL® such as CYMEL 303 and CYMEL 1128, available from Cytec Industries.

Blocked polyisocyanate crosslinking agents are typically diisocyanates such as toluene diisocyanate, 1,6-hexamethylene diisocyanate and isophorone diisocyanate including isocyanato dimers and trimers thereof in which the isocyanate groups are reacted (“blocked”) with a material such as epsilon-caprolactone and methylethyl ketoxime. At curing temperatures, the blocking agents unblock exposing isocyanate functionality that is reactive with the hydroxyl functionality associated with the other components of the binder. Blocked polyisocyanate crosslinking agents are commercially available from Covestro as DESMODUR BL.

Examples of polyepoxide crosslinking agents are epoxy-containing addition polymers such as those prepared from glycidyl methacrylate copolymerized with other vinyl monomers, polyglycidyl ethers of polyhydric phenols such as the diglycidyl ether of bisphenol A; and cycloaliphatic polyepoxides such as 3,4-epoxycyclohexylmethyl-3,4-epoxycyclohexane carboxylate and bis (3,4-epoxy-6-methylcyclohexyl-methyl) adipate.

In addition to promoting the cross-linking of the addition polymer, the crosslinking agents, including those associated with crosslinking monomers and separately added crosslinking agents, react with the hydrophilic groups, such as active hydrogen functional groups of the addition polymer preventing these groups from absorbing moisture that could be problematic in a lithium-ion battery.

The separately added crosslinker may be present in the binder in amounts of up to 25% by weight, such as 0.1% to 25% by weight, such as 0.1% to 15% by weight, such as 1% to 25% by weight, such as 1% to 15% by weight, the % by weight being based on the total weight of the binder solids.

The binder solids may be present in the slurry composition in amounts of at least 0.1% by weight, such as at least 0.5% by weight, such as at least 1% by weight, such as at least 1.5% by weight, such as at least 2% by weight, based on the total solids weight of the slurry. The binder solids may be present in the slurry composition in amounts of no more than 20% by weight, such as no more than 15% by weight, such as no more than 10% by weight, such as no more than 7.5% by weight, such as no more than 5% by weight, such as no more than 4% by weight, such as no more than 3% by weight, based on the total solids weight of the slurry. The binder solids may be present in the slurry composition in amounts of 0.1% to 20% by weight, such as 0.1% to 15% by weight, such as 0.1% to 10% by weight, such as 0.1% to 7.5% by weight, such as 0.1% to 5% by weight, such as 0.1% to 4% by weight, such as 0.1% to 3% by weight, such as 0.5% to 20% by weight, such as 0.5% to 15% by weight, such as 0.5% to 10% by weight, such as 0.5% to 7.5% by weight, such as 0.5% to 5% by weight, such as 0.5% to 4% by weight, such as 0.5% to 3% by weight, such as 1% to 20% by weight, such as 1% to 15% by weight, such as 1% to 10% by weight, such as 1% to 7.5% by weight, such as 1% to 5% by weight, such as 1% to 4% by weight, such as 1% to 3% by weight, such as 1.5% to 20% by weight, such as 1.5% to 15% by weight, such as 1.5% to 10% by weight, such as 1.5% to 7.5% by weight, such as 1.5% to 5% by weight, such as 1.5% to 4% by weight, such as 1.5% to 3% by weight, such as 2% to 20% by weight, such as 2% to 15% by weight, such as 2% to 10% by weight, such as 2% to 7.5% by weight, such as 2% to 5% by weight, such as 2% to 4% by weight, such as 2% to 3% by weight, based on the total solids weight of the slurry.

The separately added crosslinker may be present in the slurry composition in amount of at least 0.1% by weight, such as at least 0.3% by weight, such as at least 0.5% by weight, such as at least 1.0% by weight, such as at least 1.25% by weight, such as at least 1.5% by weight, such as at least 2.0% by weight, such as at least 2.5% by weight, based on the total weight of the binder solids. The separately added crosslinker may be present in the slurry composition in amount of no more than 25% by weight, such as no more than 20% by weight, such as no more than 15% by weight, such as no more than 12.5% by weight, such as no more than 10% by weight, such as no more than 7.5% by weight, such as no more than 5% by weight, such as no more than 3% by weight, such as no more than 1.5% by weight, based on the total weigh of the binder solids. The separately added crosslinker may be present in the slurry composition in amount of 0.1% to 25% by weight, such as 0.1% to 20% by weight, such as 0.1% to 15% by weight, such as 0.1% to 12.5% by weight, such as 0.1% to 10% by weight, such as 0.1% to 7.5% by weight, such as 0.1% to 5% by weight, such as 0.1% to 3% by weight, such as 0.1% to 1.5% by weight, such as 0.3% to 25% by weight, such as 0.3% to 20% by weight, such as 0.3% to 15% by weight, such as 0.3% to 12.5% by weight, such as 0.3% to 10% by weight, such as 0.3% to 7.5% by weight, such as 0.3% to 5% by weight, such as 0.3% to 3% by weight, such as 0.3% to 1.5% by weight, such as 0.5% to 25% by weight, such as 0.5% to 20% by weight, such as 0.5% to 15% by weight, such as 0.5% to 12.5% by weight, such as 0.5% to 10% by weight, such as 0.5% to 7.5% by weight, such as 0.5% to 5% by weight, such as 0.5% to 3% by weight, such as 0.5% to 1.5% by weight, such as 1.0% to 25% by weight, such as 1.0% to 20% by weight, such as 1.0% to 15% by weight, such as 1.0% to 12.5% by weight, such as 1.0% to 10% by weight, such as 1.0% to 7.5% by weight, such as 1.0% to 5% by weight, such as 1.0% to 3% by weight, such as 1.0% to 1.5% by weight, such as 1.25% to 25% by weight, such as 1.25% to 20% by weight, such as 1.25% to 15% by weight, such as 1.25% to 12.5% by weight, such as 1.25% to 10% by weight, such as 1.25% to 7.5% by weight, such as 1.25% to 5% by weight, such as 1.25% to 3% by weight, such as 1.25% to 1.5% by weight, such as 1.5% to 25% by weight, such as 1.5% to 20% by weight, such as 1.5% to 15% by weight, such as 1.5% to 12.5% by weight, such as 1.5% to 10% by weight, such as 1.5% to 7.5% by weight, such as 1.5% to 5% by weight, such as 1.5% to 3% by weight, such as 2.0% to 25% by weight, such as 2.0% to 20% by weight, such as 2.0% to 15% by weight, such as 2.0% to 12.5% by weight, such as 2.0% to 10% by weight, such as 2.0% to 7.5% by weight, such as 2.0% to 5% by weight, such as 2.0% to 3% by weight, such as 2.5% to 25% by weight, such as 2.5% to 20% by weight, such as 2.5% to 15% by weight, such as 2.5% to 12.5% by weight, such as 2.5% to 10% by weight, such as 2.5% to 7.5% by weight, such as 2.5% to 5% by weight, such as 2.5% to 3% by weight, based on the total weight of the binder solids.

The slurry composition may optionally further comprise an electrochemically active material. The material constituting the electrochemically active material contained in the slurry is not particularly limited and a suitable material can be selected according to the type of an electrical storage device of interest.

The electrochemically active material may comprise a material for use as an active material for a positive electrode. The electrochemically active material may comprise a material capable of incorporating lithium (including incorporation through lithium intercalation/deintercalation), a material capable of lithium conversion, or combinations thereof. Non-limiting examples of electrochemically active materials capable of incorporating lithium include LiCoO₂, LiNiO₂, LiFePO₄, LiCoPO₄, LiMnO₂, LiMn₂O₄, Li(NiMnCo)O₂, Li(NiCoAl)O₂, carbon-coated LiFePO₄, and combinations thereof. Non-limiting examples of materials capable of lithium conversion include sulfur, LiO₂, FeF₂ and FeF₃, Si, aluminum, tin, SnCo, Fe₃O₄, and combinations thereof.

The electrochemically active material may comprise a material for use as an active material for a negative electrode. The electrochemically active material may comprise graphite, lithium titanate, silicon compounds, tin, tin compounds, sulfur, sulfur compounds, or a combination thereof.

The electrochemically active material may be present in the slurry in amounts of 45% to 99% by weight, such as 50% to 99% by weight, such as 55% to 99% by weight, such as 60% to 99% by weight, such as 65% to 99% by weight, such as 70% to 99% by weight, such as 75% to 99% by weight, such as 80% to 99% by weight, such as 85% to 99% by weight, such as 90% to 99% by weight, such as 91% to 99% by weight, such as 94% to 99% by weight, such as 95% to 99% by weight, such as 96% to 99% by weight, such as 97% to 99% by weight, such as 98% to 99% by weight, such as 45% to 98% by weight, such as 50% to 98% by weight, such as 55% to 98% by weight, such as 60% to 98% by weight, such as 65% to 98% by weight, such as 70% to 98% by weight, such as 75% to 98% by weight, such as 80% to 98% by weight, such as 85% to 98% by weight, such as 90% to 98% by weight, such as 91% to 98% by weight, such as 94% to 98% by weight, such as 95% to 98% by weight, such as 96% to 98% by weight, such as 97% to 98% by weight, such as 45% to 96% by weight, such as 50% to 96% by weight, such as 55% to 96% by weight, such as 60% to 96% by weight, such as 65% to 96% by weight, such as 70% to 96% by weight, such as 75% to 96% by weight, such as 80% to 96% by weight, such as 85% to 96% by weight, such as 90% to 96% by weight, such as 91% to 96% by weight, such as 94% to 96% by weight, such as 95% to 96% by weight, based on the total solids weight of the slurry.

The slurry composition of the present invention may optionally further comprise an electrically conductive agent. Non-limiting examples of electrically conductive agents include carbonaceous materials such as, activated carbon, carbon black such as acetylene black and furnace black, graphite, graphene, carbon nanotubes, carbon fibers, fullerene, and combinations thereof.

The electrically conductive agent may comprise a material having a BET surface area of at least 10 m²/g, such as at least 20 m²/g, such as at least 50 m²/g, such as at least 100 m²/g, such as at least 200 m²/g, such as at least 250 m²/g, such as at least 300 m²/g, such as at least 400 m²/g, such as at least 500 m²/g, such as at least 550 m²/g, such as at least 600 m²/g, such as at least 800 m²/g, such as at least 1,000 m²/g. The electrically conductive agent may comprise a material having a BET surface area of no more than 2,000 m²/g, such as no more than 1,750 m²/g, such as no more than 1,600 m²/g, such as no more than 1,500 m²/g, such as no more than 1,400 m²/g, such as no more than 1,300 m²/g, such as no more than 1,200 m²/g, such as no more than 1,100 m²/g, such as no more than 1,000 m²/g, such as no more than 900 m²/g, such as no more than 800 m²/g, such as no more than 700 m²/g, such as no more than 600 m²/g, such as no more than 500 m²/g, such as no more than 400 m²/g, such as no more than 300 m²/g, such as no more than 200 m²/g, such as no more than 100 m²/g, such as no more than 50 m²/g. The electrically conductive agent may comprise a material having a BET surface area of 10 to 2,000 m²/g, such as 10 to 1,750 m²/g, such as 10 to 1,600 m²/g, such as 10 to 1,500 m²/g, such as 10 to 1,400 m²/g, such as 10 to 1,300 m²/g, such as 10 to 1,200 m²/g, such as 10 to 1,100 m²/g, such as 10 to 1,000 m²/g, such as 10 to 900 m²/g, such as 10 to 800 m²/g, such as 10 to 700 m²/g, such as 10 to 600 m²/g, such as 10 to 500 m²/g, such as 10 to 400 m²/g, such as 10 to 300 m²/g, such as 10 to 200 m²/g, such as 10 to 100 m²/g, such as 10 to 50 m²/g, such as 20 to 2,000 m²/g, such as 20 to 1,750 m²/g, such as 20 to 1,600 m²/g, such as 20 to 1,500 m²/g, such as 20 to 1,400 m²/g, such as 20 to 1,300 m²/g, such as 20 to 1,200 m²/g, such as 20 to 1,100 m²/g, such as 20 to 1,000 m²/g, such as 20 to 900 m²/g, such as 20 to 800 m²/g, such as 20 to 700 m²/g, such as 20 to 600 m²/g, such as 20 to 500 m²/g, such as 20 to 400 m²/g, such as 20 to 300 m²/g, such as 20 to 200 m²/g, such as 20 to 100 m²/g, such as 20 to 50 m²/g, such as 50 to 2,000 m²/g, such as 50 to 1,750 m²/g, such as 50 to 1,600 m²/g, such as 50 to 1,500 m²/g, such as 50 to 1,400 m²/g, such as 50 to 1,300 m²/g, such as 50 to 1,200 m²/g, such as 50 to 1,100 m²/g, such as 50 to 1,000 m²/g, such as 50 to 900 m²/g, such as 50 to 800 m²/g, such as 50 to 700 m²/g, such as 50 to 600 m²/g, such as 50 to 500 m²/g, such as 50 to 400 m²/g, such as 50 to 300 m²/g, such as 50 to 200 m²/g, such as 50 to 100 m²/g, such as 100 to 2,000 m²/g, such as 100 to 1,750 m²/g, such as 100 to 1,600 m²/g, such as 100 to 1,500 m²/g, such as 100 to 1,400 m²/g, such as 100 to 1,300 m²/g, such as 100 to 1,200 m²/g, such as 100 to 1,100 m²/g, such as 100 to 1,000 m²/g, such as 100 to 900 m²/g, such as 100 to 800 m²/g, such as 100 to 700 m²/g, such as 100 to 600 m²/g, such as 100 to 500 m²/g, such as 100 to 400 m²/g, such as 100 to 300 m²/g, such as 100 to 200 m²/g, such as 200 to 2,000 m²/g, such as 200 to 1,720 m²/g, such as 200 to 1,600 m²/g, such as 200 to 1,500 m²/g, such as 200 to 1,400 m²/g, such as 200 to 1,300 m²/g, such as 200 to 1,200 m²/g, such as 200 to 1,100 m²/g, such as 200 to 1,000 m²/g, such as 200 to 900 m²/g, such as 200 to 800 m²/g, such as 200 to 700 m²/g, such as 200 to 600 m²/g, such as 200 to 500 m²/g, such as 200 to 400 m²/g, such as 200 to 300 m²/g, such as 300 to 2,000 m²/g, such as 300 to 1,730 m²/g, such as 300 to 1,600 m²/g, such as 300 to 1,500 m²/g, such as 300 to 1,400 m²/g, such as 300 to 1,300 m²/g, such as 300 to 1,200 m²/g, such as 300 to 1,100 m²/g, such as 300 to 1,000 m²/g, such as 300 to 900 m²/g, such as 300 to 800 m²/g, such as 300 to 700 m²/g, such as 300 to 600 m²/g, such as 300 to 500 m²/g, such as 300 to 400 m²/g, such as 400 to 2,000 m²/g, such as 400 to 1,740 m²/g, such as 400 to 1,600 m²/g, such as 400 to 1,500 m²/g, such as 400 to 1,400 m²/g, such as 400 to 1,300 m²/g, such as 400 to 1,200 m²/g, such as 400 to 1,100 m²/g, such as 400 to 1,000 m²/g, such as 400 to 900 m²/g, such as 400 to 800 m²/g, such as 400 to 700 m²/g, such as 400 to 600 m²/g, such as 400 to 500 m²/g, such as 500 to 2,000 m²/g, such as 500 to 1,750 m²/g, such as 500 to 1,600 m²/g, such as 500 to 1,500 m²/g, such as 500 to 1,400 m²/g, such as 500 to 1,300 m²/g, such as 500 to 1,200 m²/g, such as 500 to 1,100 m²/g, such as 500 to 1,000 m²/g, such as 500 to 900 m²/g, such as 500 to 800 m²/g, such as 500 to 700 m²/g, such as 500 to 600 m²/g, such as 600 to 2,000 m²/g, such as 600 to 1,750 m²/g, such as 600 to 1,600 m²/g, such as 600 to 1,500 m²/g, such as 600 to 1,400 m²/g, such as 600 to 1,300 m²/g, such as 600 to 1,200 m²/g, such as 600 to 1,100 m²/g, such as 600 to 1,000 m²/g, such as 600 to 900 m²/g, such as 600 to 800 m²/g, such as 600 to 700 m²/g, such as 700 to 2,000 m²/g, such as 700 to 1,750 m²/g, such as 700 to 1,600 m²/g, such as 700 to 1,500 m²/g, such as 700 to 1,400 m²/g, such as 700 to 1,300 m²/g, such as 700 to 1,200 m²/g, such as 700 to 1.100 m²/g, such as 700 to 1,000 m²/g, such as 700 to 900 m²/g, such as 700 to 800 m²/g, such as 800 to 2,000 m²/g, such as 800 to 1,750 m²/g, such as 800 to 1,600 m²/g, such as 800 to 1,500 m²/g, such as 800 to 1,400 m²/g, such as 800 to 1,300 m²/g, such as 800 to 1,200 m²/g, such as 800 to 1,100 m²/g, such as 800 to 1,000 m²/g, such as 800 to 900 m²/g, such as 900 to 2,000 m²/g, such as 900 to 1,750 m²/g, such as 900 to 1,600 m²/g, such as 900 to 1,500 m²/g, such as 900 to 1,400 m²/g, such as 900 to 1,300 m²/g, such as 900 to 1,200 m²/g, such as 900 to 1,100 m²/g, such as 900 to 1,000 m²/g, such as 1,000 to 2,000 m²/g, such as 1,000 to 1,750 m²/g, such as 1,000 to 1,600 m²/g, such as 1,000 to 1,500 m²/g, such as 1,000 to 1,400 m²/g, such as 1,000 to 1,300 m²/g, such as 1,000 to 1,200 m²/g, such as 1,000 to 1,100 m²/g. As used herein, the term “BET surface area” refers to a specific surface area determined by nitrogen adsorption according to the ASTMD 3663-78 standard based on the Brunauer-Emmett-Teller method described in the periodical “The Journal of the American Chemical Society”, 60, 309 (1938).

The electrically conductive agent may be present in the slurry in amounts of at least 0.1% by weight, such as at least 0.5% by weight, such as at least 1% by weight, such as at least 1.5% by weight, such as at least 2% by weight, based on the total solids weight of the slurry. The electrically conductive agent may be present in the slurry in amounts of no more than 20% by weight, such as no more than 15% by weight, such as no more than 10% by weight, such as no more than 7.5% by weight, such as no more than 5% by weight, such as no more than 4% by weight, such as no more than 3% by weight, such as no more than 2.5% by weight, based on the total solids weight of the slurry. The electrically conductive agent may be present in the slurry in amounts of 0.1% to 20% by weight, such as 0.1% to 15% by weight, such as 0.1% to 10% by weight, such as 0.1% to 7.5% by weight, such as 0.1% to 5% by weight, such as 0.1% to 4% by weight, such as 0.1% to 3% by weight, such as 0.1% to 2.5% by weight, such as 0.5% to 20% by weight, such as 0.5% to 15% by weight, such as 0.5% to 10% by weight, such as 0.5% to 7.5% by weight, such as 0.5% to 5% by weight, such as 0.5% to 4% by weight, such as 0.5% to 3% by weight, such as 0.5% to 2.5% by weight, such as 1% to 20% by weight, such as 1% to 15% by weight, such as 1% to 10% by weight, such as 1% to 7.5% by weight, such as 1% to 5% by weight, such as 1% to 4% by weight, such as 1% to 3% by weight, such as 1% to 2.5% by weight, such as 1.5% to 20% by weight, such as 1.5% to 15% by weight, such as 1.5% to 10% by weight, such as 1.5% to 7.5% by weight, such as 1.5% to 5% by weight, such as 1.5% to 4% by weight, such as 1.5% to 3% by weight, such as 1.5% to 2.5% by weight, such as 2% to 20% by weight, such as 2% to 15% by weight, such as 2% to 10% by weight, such as 2% to 7.5% by weight, such as 2% to 5% by weight, such as 2% to 4% by weight, such as 2% to 3% by weight, such as 2% to 2.5% by weight, based on the total solids weight of the slurry.

The slurry composition may be in the form of an electrode slurry composition comprising the binder, electrochemically active material and electrically conductive material, each as described above. The electrode slurry may comprise such materials present in the slurry composition in the amounts described above. For example, the electrode slurry composition may comprise the electrochemically active material present in amounts of 45% to 99% by weight, such as 50% to 99% by weight, such as 55% to 99% by weight, such as 60% to 99% by weight, such as 65% to 99% by weight, such as 70% to 99% by weight, such as 75% to 99% by weight, such as 80% to 99% by weight, such as 85% to 99% by weight, such as 90% to 99% by weight, such as 91% to 99% by weight, such as 94% to 99% by weight, such as 95% to 99% by weight, such as 96% to 99% by weight, such as 97% to 99% by weight, such as 98% to 99% by weight, such as 45% to 98% by weight, such as 50% to 98% by weight, such as 55% to 98% by weight, such as 60% to 98% by weight, such as 65% to 98% by weight, such as 70% to 98% by weight, such as 75% to 98% by weight, such as 80% to 98% by weight, such as 85% to 98% by weight, such as 90% to 98% by weight, such as 91% to 98% by weight, such as 94% to 98% by weight, such as 95% to 98% by weight, such as 96% to 98% by weight, such as 97% to 98% by weight, such as 45% to 96% by weight, such as 50% to 96% by weight, such as 55% to 96% by weight, such as 60% to 96% by weight, such as 65% to 96% by weight, such as 70% to 96% by weight, such as 75% to 96% by weight, such as 80% to 96% by weight, such as 85% to 96% by weight, such as 90% to 96% by weight, such as 91% to 96% by weight, such as 94% to 96% by weight, such as 95% to 96% by weight, the percentages by weight based on the total solids weight of the electrode slurry composition.

The electrode slurry composition comprising the solvent system, electrochemically active material, electrically conductive material, binder (which may include a separately added crosslinking agent), and optional ingredients, may be prepared by combining the ingredients to form the slurry. These substances can be mixed together by agitation with a known means such as a stirrer, bead mill or high-pressure homogenizer.

As for mixing and agitation for the manufacture of the electrode slurry composition, a mixer capable of stirring these components to such an extent that satisfactory dispersion conditions are met should be selected. The degree of dispersion can be measured with a particle gauge and mixing and dispersion are preferably carried out to ensure that agglomerates of 100 microns or more are not present. Examples of the mixers which meets this condition include ball mill, sand mill, pigment disperser, grinding machine, extruder, rotor stator, pug mill, ultrasonic disperser, homogenizer, planetary mixer, Hobart mixer, and combinations thereof.

The slurry composition may have a solids content of at least 10% by weight, such as at least 30% by weight, such as at least 40% by weight, such as at least 50% by weight, such as at least 55%, such as at least 60%, such as at least 65%, such as at least 71%, such as at least 75%, and may be no more than 90% by weight, such as no more than 85% by weight, such as no more than 75% by weight, the % by weight based on the total weight of the slurry composition. The slurry composition may have a solids content of 30% to 90% by weight, such as 40% to 85% by weight, such as 50% to 85% by weight, such as 55% to 85% by weight, such as 60% to 85% by weight, such as 65% to 85% by weight, such as 71% to 85% by weight, such as 75% to 85% by weight, based on the total weight of the slurry composition.

The present invention is also directed to an electrode comprising an electrical current collector and a film on the electrical current collector, wherein the film comprises an electrochemically active material and a fluoropolymer, and optionally an electrically conductive agent. The film may optionally further comprise a separately added crosslinking agent and/or an addition polymer, as described herein. The film may be deposited from the electrode slurry composition described above, and the film may optionally further comprise residual solvent comprising any of the solvent systems described herein. As used herein, the term “residual solvent” refers to solvent remaining in the film after the slurry composition has been applied to the current collector and dried and/or cured. The film may comprise residual solvent in an amount of at least 1 ppm, such as at least 20 ppm, such as at least 50 ppm. The film may comprise residual solvent in an amount of less than 2,000 ppm, or less than 1,000 ppm, or less than 200 ppm, or less than 50 ppm. The film may comprise residual solvent in an amount of 1 to 2,000 ppm, such as 1 to 1,000 ppm, such as 1 to 200 ppm, such as 1 to 50 ppm, such as 20 to 2,000 ppm, such as 20 to 1,000 ppm, such as 20 to 200 ppm, such as 20 to 50 ppm, such as 50 to 2,000 ppm, such as 50 to 1,000 ppm, such as 50 to 200 ppm.

The electrode may be a positive electrode or a negative electrode and may be manufactured by applying the above-described slurry composition to the surface of the current collector to form a coating film, and subsequently drying and/or curing the coating film. The coating film may have a thickness of at least 1 micron, such as 1 to 500 microns (μm), such as 1 to 150 μm, such as 25 to 150 μm, such as 30 to 125 μm. The coating film may comprise a crosslinked coating, and the film may further comprise the residue of a crosslinking agent. The current collector may comprise a conductive material, and the conductive material may comprise a metal such as iron, copper, aluminum, nickel, and alloys thereof, as well as stainless steel. For example, the current collector may comprise aluminum or copper in the form of a mesh, sheet or foil. Although the shape and thickness of the current collector are not particularly limited, the current collector may have a thickness of about 0.001 to 0.5 mm, such as a mesh, sheet or foil having a thickness of about 0.001 to 0.5 mm.

In addition, the current collector may be pretreated with a pretreatment composition prior to depositing the slurry composition. As used herein, the term “pretreatment composition” refers to a composition that upon contact with the current collector, reacts with and chemically alters the current collector surface and binds to it to form a protective layer. The pretreatment composition may be a pretreatment composition comprising a group IIIB and/or IVB metal. As used herein, the term “group IIIB and/or IVB metal” refers to an element that is in group IIIB or group IVB of the CAS Periodic Table of the Elements as is shown, for example, in the Handbook of Chemistry and Physics, 63^{rd} edition (1983). Where applicable, the metal themselves may be used, however, a group IIIB and/or IVB metal compound may also be used. As used herein, the term “group IIIB and/or IVB metal compound” refers to compounds that include at least one element that is in group IIIB or group IVB of the CAS Periodic Table of the Elements. Suitable pretreatment compositions and methods for pretreating the current collector are described in U.S. Pat. No. 9,273,399 at col. 4, line 60 to col. 10, line 26, the cited portion of which is incorporated herein by reference. The pretreatment composition may be used to treat current collectors used to produce positive electrodes or negative electrodes.

The method of applying the slurry composition to the current collector is not particularly limited. The slurry composition may be applied by doctor blade coating, dip coating, reverse roll coating, direct roll coating, gravure coating, extrusion coating, immersion or brushing. Although the application quantity of the slurry composition is not particularly limited, the thickness of the coating formed after the solvent system is removed may be 25 to 150 microns (μm), such as 30 to 125 μm.

Drying and/or crosslinking the coating film after application, if applicable, can be done, for example, by heating at elevated temperature, such as at least 50° C., such as at least 60° C., such as 50-145° C., such as 60-120° C., such as 65-110° C. The time of heating will depend somewhat on the temperature. Generally, higher temperatures require less time for curing. Typically, curing times are for at least 5 minutes, such as 5 to 60 minutes. The temperature and time should be sufficient such that the addition polymer in the cured film is crosslinked (if applicable), that is, covalent bonds are formed between co-reactive groups on the addition polymer polymer chain(s), such as carboxylic acid groups and hydroxyl groups and the N-methylol and/or the N-methylol ether groups of an aminoplast, isocyanato groups of a blocked polyisocyanate crosslinking agent, or in the case of a self-curing addition polymer, the N-alkoxymethyl amide groups. The extent of cure or crosslinking may be measured as resistance to solvents such as methyl ethyl ketone (MEK). The test is performed as described in ASTM D-540293. The number of double rubs, one back and forth motion, is reported. This test is often referred to as “MEK Resistance”. Accordingly, the addition polymer and crosslinking agent (inclusive of self-curing addition polymers and addition polymers with separately added crosslinking agents) is isolated from the binder composition, deposited as a film, and heated for the temperature and time that the binder film is heated. The film is then measured for MEK Resistance with the number of double rubs reported. Accordingly, a crosslinked addition polymer will have an MEK Resistance of at least 50 double rubs, such as at least 75 double rubs. Also, the crosslinked addition polymer may be substantially solvent resistant to the solvents of the electrolyte mentioned below. Other methods of drying the coating film include ambient temperature drying (e.g., 25° C.), microwave drying and infrared drying, and other methods of curing the coating film include e-beam curing and UV curing.

During discharge of a lithium-ion electrical storage device, lithium ions may be released from the negative electrode and carry the current to the positive electrode. This process may include the process known as deintercalation. During charging, the lithium ions migrate from the electrochemically active material in the positive electrode to the negative electrode where they become embedded in the electrochemically active material present in the negative electrode. This process may include the process known as intercalation.

The present invention is also directed to an electrical storage device. An electrical storage device according to the present invention can be manufactured by using the above electrodes prepared from the electrode slurry composition of the present invention. The electrical storage device comprises an electrode, a counter electrode, and an electrolyte. The electrode, counter-electrode or both may comprise the electrode of the present invention, as long as one electrode is a positive electrode, and one electrode is a negative electrode. Electrical storage devices according to the present invention include a cell, a battery, a battery pack, a secondary battery, a capacitor, and a supercapacitor.

The electrical storage device includes an electrolytic solution and can be manufactured by using parts such as a separator in accordance with a commonly used method. As a more specific manufacturing method, a negative electrode and a positive electrode are assembled together with a separator there between, the resulting assembly is rolled or bent in accordance with the shape of a battery and put into a battery container, an electrolytic solution is injected into the battery container, and the battery container is sealed up. The shape of the battery may be like a coin, button, or sheet, cylindrical, square or flat.

The electrolytic solution may be liquid or gel, and an electrolytic solution which can serve effectively as a battery may be selected from among known electrolytic solutions which are used in electrical storage devices in accordance with the types of a negative electrode active material and a positive electrode active material. The electrolytic solution may be a solution containing an electrolyte dissolved in a suitable solvent. The electrolyte may be conventionally known lithium salt for lithium-ion secondary batteries. Examples of the lithium salt include LiClO₄, LiBF₄, LiPF₆, LiCF₃CO₂, LiAsF₆, LiSbF₆, LiB₁₀Cl₁₀, LiAlCl₄, LiCl, LiBr, LiB(C₂H₅)₄, LiB(C₆H₅)₄, LiCF₃SO₃, LiCH₃SO₃, LiCAF₉SO₃, Li(CF₃SO₂)₂N, LiB₄CH₃SO₃Li and CF₃SO₃Li. The solvent for dissolving the above electrolyte is not particularly limited and examples thereof include carbonate compounds such as propylene carbonate, ethylene carbonate, butylene carbonate, dimethyl carbonate, methyl ethyl carbonate and diethyl carbonate; lactone compounds such as γ-butyl lactone; ether compounds such as trimethoxymethane, 1,2-dimethoxyethane, diethyl ether, 2-ethoxyethane, tetrahydrofuran and 2-methyltetrahydrofuran; and sulfoxide compounds such as dimethyl sulfoxide. The concentration of the electrolyte in the electrolytic solution may be 0.5 to 3.0 mole/L, such as 0.7 to 2.0 mole/L.

The present invention is also directed to a method of manufacturing films comprising a fluoropolymer using the binder of the present invention. The films may comprise artificial leather, polymer suede, polymer fibers, coatings, membranes, dental applications, piezoelectric films, electronic circuits, or for the protection of electric cables. The films may be produced from the binder composition of the present invention using any suitable method, such as, for example, any method that will remove the solvent system to result in the formation of a continuous film comprising the fluoropolymer. For example, the method may comprise evaporating the solvent system, with or without heating, dipping in a water bath, or any other suitable coagulation or phase inversion technique.

As used herein, the term “polymer” refers broadly to oligomers and both homopolymers and copolymers. The term “resin” is used interchangeably with “polymer”.

The terms “acrylic” and “acrylate” are used interchangeably (unless to do so would alter the intended meaning) and include acrylic acids, anhydrides, and derivatives thereof, such as their C₁-C₅ alkyl esters, lower alkyl-substituted acrylic acids, e.g., C₁-C₂ substituted acrylic acids, such as methacrylic acid, 2-ethylacrylic acid, etc., and their C₁-C₄ alkyl esters, unless clearly indicated otherwise. The terms “(meth)acrylic” or “(meth)acrylate” are intended to cover both the acrylic/acrylate and methacrylic/methacrylate forms of the indicated material, e.g., a (meth)acrylate monomer.

As used herein molecular weights are determined by gel permeation chromatography using a polystyrene standard. Unless otherwise indicated molecular weights are on a weight average basis. As used herein, the term “weight average molecular weight” or “(M_{w})” means the weight average molecular weight (M_{w}) as determined by gel permeation chromatography using a polystyrene standard according to ASTM D6579-11 (“Standard Practice for Molecular Weight Averages and Molecular Weight Distribution of Hydrocarbon, Rosin and Terpene Resins by Size Exclusion Chromatography”. UV detector; 254 nm, solvent: unstabilised THF, retention time marker: toluene, sample concentration: 2 mg/ml). As used herein, the term “number average molecular weight” or “(Mₙ)” means the number average molecular weight (Mₙ) as determined by gel permeation chromatography using a polystyrene standard according to ASTM D6579-11 (“Standard Practice for Molecular Weight Averages and Molecular Weight Distribution of Hydrocarbon, Rosin and Terpene Resins by Size Exclusion Chromatography”. UV detector; 254 nm, solvent: unstabilised THF, retention time marker: toluene, sample concentration: 2 mg/ml).

The term “glass transition temperature” as used herein is a theoretical value, being the glass transition temperature as calculated by the method of Fox on the basis of monomer composition of the monomer charge according to T. G. Fox, Bull. Am. Phys. Soc. (Ser. II) 1, 123 (1956) and J. Brandrup, E. H. Immergut, Polymer Handbook 3^{rd} edition, John Wiley, New York, 1989.

As used herein, unless otherwise defined, the term substantially free means that the component is present, if at all, in an amount of less than 5% by weight, based on the total weight of the slurry composition.

As used herein, unless otherwise defined, the term essentially free means that the component is present, if at all, in an amount of less than 1% by weight, based on the total weight of the slurry composition.

As used herein, unless otherwise defined, the term completely free means that the component is not present in the slurry composition, i.e., 0.00% by weight, based on the total weight of the slurry composition.

As used herein, the term “total solids” refers to the non-volatile components of the slurry composition of the present invention and specifically excludes the solvent system.

As used herein, the term “binder solids” refers to the film-forming components that form the binder of the slurry composition and/or bind the components together in the electrode film. The binder solids include the fluoropolymer and, if present, the addition polymer, and/or the separately added crosslinking agent.

As used herein, the term “residue of” when referring to the composition of a polymer refers to a singular molecular unit within the polymer that results from incorporation (i.e., reaction) of a monomer during polymerization.

As used herein, the term “consists essentially of” includes the recited material or steps and those that do not materially affect the basic and novel characteristics of the claimed invention.

As used herein, the term “consists of” excludes any element, step or ingredient not recited.

For purposes of the detailed description, it is to be understood that the invention may assume various alternative variations and step sequences, except where expressly specified to the contrary. Moreover, other than in any operating examples, or where otherwise indicated, all numbers such as those expressing values, amounts, percentages, ranges, subranges and fractions may be read as if prefaced by the word “about,” even if the term does not expressly appear. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques. Where a closed or open-ended numerical range is described herein, all numbers, values, amounts, percentages, subranges and fractions within or encompassed by the numerical range are to be considered as being specifically included in and belonging to the original disclosure of this application as if these numbers, values, amounts, percentages, subranges and fractions had been explicitly written out in their entirety.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

As used herein, unless indicated otherwise, a plural term can encompass its singular counterpart and vice versa, unless indicated otherwise. For example, although reference is made herein to “an” electrochemically active material, “a” fluoropolymer, “a” dispersant, and “an” electrically conductive agent, a combination (i.e., a plurality) of these components can be used. In addition, in this application, the use of “or” means “and/or” unless specifically stated otherwise, even though “and/or” may be explicitly used in certain instances.

As used herein, “including.” “containing” and like terms are understood in the context of this application to be synonymous with “comprising” and are therefore open-ended and do not exclude the presence of additional undescribed or unrecited elements, materials, ingredients, or method steps. As used herein, “consisting of” is understood in the context of this application to exclude the presence of any unspecified element, ingredient, or method step. As used herein, “consisting essentially of” is understood in the context of this application to include the specified elements, materials, ingredients, or method steps “and those that do not materially affect the basic and novel characteristic(s)” of what is being described. Although various embodiments of the invention have been described in terms of “comprising”, embodiments consisting essentially of or consisting of are also within the scope of the present invention.

As used herein, the terms “on,” “onto,” “applied on,” “applied onto,” “formed on.” “deposited on.” “deposited onto,” mean formed, overlaid, deposited, or provided on but not necessarily in contact with the surface. For example, a composition “deposited onto” a substrate does not preclude the presence of one or more other intervening coating layers of the same or different composition located between the electrodepositable coating composition and the substrate.

Whereas specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof. Each of the characteristics and examples described herein, and combinations thereof, may be said to be encompassed by the present invention.

Illustrating the invention are the following examples, which, however, are not to be considered as limiting the invention to their details. Unless otherwise indicated, all parts and percentages in the following examples, as well as throughout the specification, are by weight.

### Examples

Chemical Suppliers: PVDF was purchased from Solvay (PVDF Solef 5130). Triethylphosphate (TEP) was from the Eastman Chemical Company. DMSO and ε-caprolactone were from Fisher Scientific, and γ-butyrolactone was from Sigma Aldrich. Active material NMC 811 and conductive carbon Super P were both from Gelon.

### Preparation of TEP/ε-Caprolactone PVDF Binder Solutions

In a nitrogen filled glove bag, 13.06 grams of TEP and 5.34 grams of ε-Caprolactone was mixed in a 20 mL glass vial. 9.2 grams of the solvent mixture was transferred into another 20 mL glass vial. The solvent mixture was nitrogen capped and kept at 60° C. on a hotplate. 0.8 grams of PVDF was added into the heated solvent under nitrogen and started dissolving with vigorous stirring. The 8 wt % PVDF solution gradually became clear after about 1 hour. The binder solution was stable at room temperature for over a month.

### Preparation of TEP/γ-Butyrolactone PVDF Binder Solutions

In a nitrogen filled glove bag. 14.18 grams of TEP and 4.22 grams of γ-butyrolactone was mixed in a 20 mL glass vial. 9.2 grams of the solvent mixture was transferred into another 20 mL glass vial. The solvent mixture was nitrogen capped and kept at 60° C. on a hotplate. 0.8 grams of PVDF was added into the heated solvent under nitrogen and started dissolving with vigorous stirring. The 8 wt % PVDF solution gradually became clear after about 1 hour. The binder solution was stable at room temperature for about a week.

### Preparation of TEP/DMSO PVDF Binder Solutions

In a nitrogen filled glove bag. 13.88 grams of TEP and 4.52 grams of DMSO was mixed in a 20 mL glass vial. 9.2 grams of the solvent mixture was transferred into another 20 mL glass vial. The solvent mixture was nitrogen capped and kept at 60° C. on a hotplate. 0.8 grams of PVDF was added into the heated solvent under nitrogen and started dissolving with vigorous stirring. The 8 wt % PVDF solution gradually became clear after about 1 hour. The binder solution was stable at room temperature for over a month.

### Preparation of TEP/ε-Caprolactone/PVP PVDF Binder Solutions

In a nitrogen filled glove bag. 13.06 grams of TEP and 5.34 grams of ε-caprolactone was mixed in a 20 mL glass vial. 9.2 grams of the solvent mixture was transferred into another 20 mL glass vial. The solvent mixture was nitrogen capped and kept at 60° C. on a hotplate. 0.72 grams of PVDF and 0.08 grams of PVP were added sequentially into the heated solvent under nitrogen. The PVDF started dissolving at 60° C. under vigorous stirring. The 8 wt % PVDF solution gradually became clear after about 1 hour. The binder solution was stable at room temperature for over a month.

### Preparation of Comparative NMP Binder Solution

In a nitrogen filled glove bag, 0.8 grams of PVDF was gradually added into 9.2 grams of NMP in a 20 mL glass vial. The solution was nitrogen capped and kept at 60° C. on a hotplate. The PVDF started dissolving at 60° C. under vigorous stirring. The 8 wt % PVDF solution gradually became clear after about 30 minutes. The binder solution was stable at room temperature for over a month.

### Preparation of Positive Electrode Slurry

The whole process was conducted in a nitrogen glove bag. In a 50-gram scale, 8.75 grams of the binder was added into a Thinky cup, followed by 0.7 grams of carbon black Super P and 6.95 grams of solvent (or solvent mixture) that was the same as used in preparing the binder. The Thinky cup was capped, removed from the glove bag and centrifuged at 2000 rpm for 3×1 minutes. Once homogenous, the slurry was returned to the glove bag and added with 33.6 grams of active material NMC811. Wooden sticks were used to stir the slurry first, and then centrifuged outside the bag with the same conditions as before. The completed formulation was capped under nitrogen in the Thinky cup. The theoretical solids content of the slurry was 70% by weight, among which the solid consisted of binder (2% by weight based on total solids), conductive materials (2% by weight based on total solids) and electrode active materials (96% by weight based on total solids).

### Positive Electrode Slurry Rheology

The rheology of the slurry was measured by Anton Paar MCT 302 rheometer with a 50 mm diameter cone-plate at 25° C. Viscosity of slurry prepared from binder in TEP/lactone is higher (15,000-25,000 cP at 10 s⁻¹) than that of TEP/DMSO (<15,000 cP at 10 s⁻¹). With addition of 0.8% PVP in the binder, the slurry viscosity for both the TEP/lactone and TEP/DMSO significantly decreased to 5,000-15,000 cP at 10 s⁻¹.

| Slurry Solvent | DMSO/ | TEP/ | TEP/ | |
|---|---|---|---|---|
| System | TEP | Caprolactone | Butyrolactone | NMP |
| Slurry Viscosity at | 13,476 | 19,202 | 24,585 | 7,062 |
| 10/s | | | | |
| Slurry Particle size | 12 | 20 | 20 | 8 |
| (μm) | | | | |
| Slurry Viscosity (at | 18166 | 25759 | 17269 | 7703 |
| 10 s⁻¹) | | | | |
| Slurry Viscosity (at | 4674 | 13536 | 11289 | 3704 |
| 10 s⁻¹) with 0.2% | | | | |
| additive | | | | |

### Preparation of Electrode Films and Peel Strength Measurement

The as-prepared slurries were cast on to an aluminum foil with a 3 mil (76.2 microns) draw down bar. The deposited films were cured in ovens at 55° C. and 120° C. for 2 minutes in each oven in sequence. The film was pressed using a calendar press to a porosity of 30% and the films had a dry film thickness within 10-30 microns. The coating density of the film was about 20 mg/cm² for each.

The strip of coated aluminum foil was attached to an untreated aluminum panel using 3M 444 double sided tape. The peel strength was measured using a 90-degree peel test on MARK-10 ESM303 at a speed of 50 mm/min. This test is referred to herein as the PEEL STRENGTH TEST. Electrodes produced from the TEP/lactone-based binders showed average peel strength of about 5-10 N/m, and the peel strength increased to about 10-20 N/m with the addition of 0.8% PVP in the binder. The TEP/DMSO system showed about 15-20 N/m initially, and the peel strength increased to about 20-30 N/m with addition of 0.8% PVP in the binder.

| Slurry Solvent | DMSO/ | TEP/ | TEP/ | |
|---|---|---|---|---|
| System | TEP | Caprolactone | Butyrolactone | NMP |
| Average Peel | 18.01 | 7.58 | 8.57 | 18.94 |
| Strength (N/m) | | | | |
| Std Dev | 1.95 | 2.25 | 1.37 | 2.97 |
| Average Peel | 26.2 | 16.63 | 14.47 | 28.03 |
| Strength w/0.8% | | | | |
| PVP (N/m) | | | | |
| Std Dev | 4.09 | 3.62 | 2.5 | 3.56 |

### Evaluation of Electrodes in Half-Cell Coin Cells

Electrodes were tested in half cell coin cells. The prepared electrodes were cut into a disk with 10 mm in diameter. Lithium metal was used as the counter electrode and the electrolyte was 75 μL 1.0 M LiPF₆ in ethyl carbonate/ethyl methyl carbonate (EC/EMC) (3:7, v:v). Battery cells were evaluated by Bio-Logic BCS-805 tester. The cells were tested at 0.1 C, 0.2 C, 0.4 C, 0.8 C, and 1.6 C each for 5 cycles, respectively, and 1.0 C for long term cycling. As shown in the table below, comparing the initial capacity, capacity retention (50 cycles@1 C discharging), and 1^{st} CE, there is no obvious battery performance difference between the electrodes of the present invention and those prepared using NMP. The results indicate new solvents didn't influence the electrochemical properties in the lithium-ion half-cell coin cells.

| | DMSO/ | TEP/ | TEP/ | |
|---|---|---|---|---|
| Slurry Solvent System | TEP | Caprolactone | Butyrolactone | NMP |
| Initial capacity | 195-198 | 192-193 | 193-194 | 191-195 |
| (mAh/g) | | | | |
| Capacity retention (1 C, | 98.4-99.1% | 98.7-99.4% | 95.4-98.52% | 98.7-99.3% |
| 50 cycles) | | | | |
| 1^{st} Coulombic | 86-87% | 86-87% | 83-86% | 87% |
| Efficiency (%) | | | | |

It will be appreciated by skilled artisans that numerous modifications and variations are possible in light of the above disclosure without departing from the broad inventive concepts described and exemplified herein. Accordingly, it is therefore to be understood that the foregoing disclosure is merely illustrative of various exemplary aspects of this application and that numerous modifications and variations can be readily made by skilled artisans which are within the spirit and scope of this application and the accompanying claims.

1. A binder composition comprising:
(a) at least one fluoropolymer comprising the residue of vinylidene fluoride; and
(b) a solvent system comprising:
(i) a trialkyl phosphate; and
(ii) a co-solvent comprising a lactone and/or a molecule comprising a sulfoxide and/or sulfone functional group;
wherein the trialkyl phosphate and the co-solvent together comprise at least 50% by weight of the solvent system, based on the total weight of the solvent system.

2. (canceled)

3. The binder composition of claim 1, wherein the solvent system comprises:
(i) 0.1% to 99.9% by weight of the trialkyl phosphate; and
(ii) 0.1% to 99.9% by weight of the lactone, the % by weight based on the total weight of the solvent system.

4. The binder composition of claim 1, wherein the solvent system comprises:
(i) 50% to 99.9% by weight of the trialkyl phosphate; and
(ii) 0.1% to 50% by weight of the molecule comprising a sulfoxide and/or sulfone functional group, the % by weight based on the total weight of the solvent system.

5. The binder composition of claim 1, wherein the trialkyl phosphate comprises trimethyl phosphate, triethyl phosphate, tributyl phosphate, or any combination thereof.

6. The binder composition of claim 1, wherein the lactone comprises ε-caprolactone, γ-butyrolactone, or any combination thereof.

7. The binder composition of claim 1, wherein the molecule comprising a sulfoxide functional group comprises dimethyl sulfoxide.

8. The binder composition of claim 1, wherein the molecule comprising a sulfone functional group comprises tetramethylene sulfone.

9-10. (canceled)

11. The binder composition of claim 1, wherein the fluoropolymer is solubilized in the solvent system at room temperature.

12. The binder composition of claim 1, further comprising a dispersant comprising polyvinylpyrrolidone.

13. (canceled)

14. The binder composition of claim 1, further comprising a crosslinking agent.

15. (canceled)

16. A slurry composition comprising:
the binder composition of claim 1; and
an electrochemically active material.

17. The slurry composition of claim 16, wherein the solvent system comprises the trialkyl phosphate and the lactone, and:
the slurry composition has a viscosity of 5,000 to 25,000 cP at 10 s⁻¹, as measured by Anton Paar MCR 302 rheometer with a 50 mm diameter cone-plate at 25° C.;
the slurry composition has a room temperature stability of ≥1 week; and/or
a film deposited from the slurry composition has a peel strength of at least 5 N/m, as measured by the PEEL STRENGTH TEST.

18-19. (canceled)

20. The slurry composition of claim 16, wherein the solvent system comprises the trialkyl phosphate and the molecule comprising a sulfoxide and/or sulfone functional group, and:
the slurry composition has a viscosity of 5,000 to 25,000 cP at 10 s⁻¹, as measured by Anton Paar MCR 302 rheometer with a 50 mm diameter cone-plate at 25° C.;
the slurry composition has a room temperature stability of ≥1 month; and/or
a film deposited from the slurry composition has a peel strength of at least 15 N/m, as measured by the PEEL STRENGTH TEST.

21-23. (canceled)

24. The slurry composition of claim 16, wherein the electrochemically active material comprises a material capable of incorporating lithium comprising LiCoO₂, LiNiO₂, LiFePO₄, LiCoPO₄, LiMnO₂, LiMn₂O₄, Li(NiMnCo)O₂, Li(NiCoAl)O₂, carbon-coated LiFePO₄, or a combination thereof.

25. (canceled)

26. The slurry composition of claim 16, wherein the electrochemically active material comprises a material capable of lithium conversion comprising sulfur, LiO₂, FeF₂ and FeF₃, Si, aluminum, tin, SnCo, Fe₃O₄, or combinations thereof.

27. (canceled)

28. The slurry composition of claim 16, wherein the electrochemically active material comprises graphite, silicon compounds, tin, tin compounds, sulfur, sulfur compounds, or a combination thereof.

29. The slurry composition of claim 16, wherein the slurry composition further comprises an electrically conductive agent.

30. (canceled)

31. A slurry composition comprising:
the binder composition of claim 1; and
an electrically conductive agent.

32-33. (canceled)

34. An electrode comprising:
(A) an electrical current collector; and
(B) a film on the electrical current collector, wherein the film comprises:
(1) a binder formed from the binder composition of claim 1, wherein the film further comprises residual solvent comprising the solvent system; and
(2) an electrochemically active material.

35-40. (canceled)

41. An electrical storage device comprising:
(a) the electrode of claim 34;
(b) a counter electrode; and
(c) an electrolyte.

42-44. (canceled)
